(19) United States
(12) Patent Application Publication
(10) Pub. No.: US 2005/0216511 A1
(43) Pub. Date: Sep. 29, 2005

(54) Guidance information retrieval apparatus and guidance information retrieval system using this guidance information retrieval apparatus

(75) Inventors: Masaharu Umezu, Tokyo (JP); Makoto Mikuriya, Tokyo (JP); Tomoya Ikeuchi, Tokyo (JP); Mitsuo Simotani, Tokyo (JP)

Correspondence Address: SUGHRUE MION, PLLC, 2100 PENNSYLVANIA AVENUE, N.W., SUITE 800, WASHINGTON, DC, 20037, US

(73) Assignee: MITSUBISHI DENKI KABUSHIKI KAISHA

(21) Appl. No.: 11/032,178

(22) Filed: Jan. 11, 2005

(30) Foreign Application Priority Data
Mar. 23, 2004 (JP) 2004-85164

(51) Int. Cl. G06F 7/00

(52) U.S. Cl. 707/104.1

(57) ABSTRACT

A guidance information retrieval apparatus includes a data holding unit (11) for holding guidance retrieval data including category data specifying categories in which retrieval targets are put, and substance data respectively specifying the substances of retrieval targets, another data holding unit (12) for holding update data including correction data for correcting category or substance data and additional data for adding new category or substance data to the guidance retrieval data, and a control unit (13) for, when the update data has correction data corresponding to category or substance data contained in the guidance retrieval data, outputting a category, in which a retrieval target corresponding to the correction data is put, or the substance of the retrieval target, and for, when the update data has additional data, outputting a category, in which a retrieval target corresponding to the additional data is put, or the substance of the retrieval target.

### BACKGROUND OF THE INVENTION

1. Field of the Invention

The present invention relates to a guidance information retrieval apparatus that retrieves guidance information so as to acquire information about a retrieval target, and a guidance information retrieval system using this guidance information retrieval apparatus. More particularly, it relates to a technology for searching for information a retrieval target using the latest guidance information.

2. Description of Related Art

Conventionally, there has been provided a vehicle-mounted navigation apparatus that is so constructed as to search for either facilities whose names are unfamiliar to users or facilities that satisfy desired search conditions from a retrieval database including guidance retrieval data that consist of facilities information and so on (see patent reference 1, for example). When the user selects, as search conditions, “restaurant”, “India food”, and so on in turn, the prior art vehicle-mounted navigation apparatus displays a list of restaurant names that satisfy the desired search conditions fromthe retrievaldatabase. When the user further selects one restaurant name from the list of restaurant names displayed, the prior art vehicle-mounted navigation apparatus can display either the position of the selected restaurant or information about the restaurant on an on-screen map. Furthermore, this vehicle-mounted navigation apparatus is so constructed as to record the retrieval database to a rewritable medium and to provide the latest facilities information for the user by rewriting the retrieval database.

Patent reference 2 discloses a map information processing apparatus for updating map data for use in a moving object, such as a car navigation system, a mobile phone, or a personal digital assistant. The prior art map information processing apparatus updates the map data stored in a storage unit according to update operation information about update processing to be performed on the map data, and stores the updated map data in the storage unit. As a result, since the prior art map information processing apparatus can update the map data without calculating information required for the updating, the prior art map information processing apparatus can carry out the update processing in a short time.
[Patent reference 1] JP,9-97007,A
[Patent reference 2] JP,2002-207423,A

In general, when map data or guidance retrieval data for use in prior art vehicle-mounted navigation apparatus are upgraded, a storage medium in which the updated map data or guidance retrieval data are stored is provided to the user by the maker of the prior art vehicle-mounted navigation apparatus. Therefore, the user can use the latest map data or guidance retrieval data by simply applying the storage medium which is provided by the maker with the updating of the map data or guidance retrieval data to the prior art vehicle-mounted navigation apparatus.

In recent years, a so-called HDD navigation system in which map data and guidance retrieval data are stored in a hard disk built in a vehicle-mounted navigation apparatus or the like has been developed and is becoming pervasive. This prior art HDD navigation system needs to replace the map data or guidance retrieval data already stored in the hard disk with updated map data or guidance retrieval data which are provided by the maker of the HDD navigation system as needed.

In general, a retrieval database for use in the vehicle-mounted navigation apparatus disclosed in above-mentioned patent reference 1 has a size ranging from several hundreds of MB to several GB, and therefore it takes huge time to rewrite the whole of the retrieval database. In order to solve the problem, there has been provided a retrieval database having a tree structure, only part to be updated of the retrieval database being rewritten with update data. In the retrieval database having a tree structure, it is however necessary to move data and to rewrite pointers with rewriting of the retrieval database. Therefore, there remains a problem that rewriting of some data of the retrieval database takes some time, although the time required for rewriting some data of the retrieval database is not more than that required for rewriting the whole of the retrieval database.

Although the technology disclosed in patent reference 2 is not for updating of data required for searching for facilities, but is for updating of map data, the storing of the map data takes larger time with increase in the size of the map data and therefore the updating of the map takes some time too.

### SUMMARY OF THE INVENTION

The present invention is made in order to solve the above-mentioned problems, and it is therefore an object of the present invention to provide a guidance information retrieval apparatus that can retrieve the latest guidance information without having to rewrite an existing guidance retrieval data, and a guidance information retrieval system using this guidance information retrieval apparatus.

In accordance with an aspect of the present invention, there is provided a guidance information retrieval apparatus including: a guidance retrieval data holding unit for holding guidance retrieval data including both category data each specifying a category in which retrieval targets are put, and substance data each specifying substance of a corresponding retrieval target; an update data holding unit for holding update data including both correction data each used for correcting either category data or substance data which constitutes the guidance retrieval data, and additional data each used for adding new category data or substance data to the guidance retrieval data; a control unit for, when correction data corresponding to either category data or substance data contained in the guidance retrieval data acquired from the guidance retrieval data holding unit is contained in the update data acquired from the update data holding unit, outputting either a category in which a retrieval target corresponding to the correction data is put or substance of the retrieval target, and for, when additional data is contained in the update data acquired from the update data holding unit, outputting either a category in which a retrieval target corresponding to the additional data is put or substance of the retrieval target; and a providing unit for providing the category in which the retrieval target is put or the substance of the retrieval target according to the output of the control unit.

In accordance with another aspect of the present invention, there is provided a guidance information retrieval system including a guidance information retrieval apparatus and a center apparatus connected by radio to the guidance information retrieval apparatus, the guidance information retrieval apparatus including: a guidance retrieval data holding unit for holding guidance retrieval data including both category data each specifying a category in which retrieval targets are put, and substance data each specifying substance of a corresponding retrieval target; an update data receiving unit for receiving update data including both correction data each used for correcting either category data or substance data which constitutes the guidance retrieval data, and additional data each used for adding new category data or substance data to the guidance retrieval data from the center apparatus; an update data holding unit for holding the update data received by the update data receiving unit; a control unit for, when correction data corresponding to either category data or substance data contained in the guidance retrieval data acquired from the guidance retrieval data holding unit is contained in the update data acquired from the update data holding unit, outputting either a category in which a retrieval target corresponding to the correction data is put or substance of the retrieval target, and for, when additional data is contained in the update data acquired from the update data holding unit, outputting either a category in which a retrieval target corresponding to the additional data is put or substance of the retrieval target; and a providing unit for providing the category in which the retrieval target is put or the substance of the retrieval target according to the output of the control unit, and the center apparatus including: an update data storing unit for storing the update data; and an update data transmitting unit for transmitting the update data stored in the update data storing unit to the guidance information retrieval apparatus.

As previously mentioned, the guidance information retrieval apparatus in according to the aspect of the present invention stores update data, which are used for correcting the existing guidance retrieval data currently being held by the guidance retrieval data holding unit or adding data to the guidance retrieval data, in the update data holding unit, and can perform guidance retrieval processing while referring to both the guidance retrieval data and the update data. Therefore, even when the guidance retrieval data are updated, the guidance information retrieval apparatus need not to rewrite the guidance retrieval data. The guidance information retrieval apparatus can thus search through the latest guidance information for desired retrieval targets without rewriting the existing guidance retrieval data.

As previously mentioned, the guidance information retrieval apparatus in accordance with the other aspect of the present invention is so constructed as to upgrade the update data held by the update data holding unit according to the latest version of update data received from the center apparatus. Therefore, the guidance information retrieval apparatus can easily and quickly upgrade the update data stored therein.

Further objects and advantages of the present invention will be apparent from the following description of the preferred embodiments of the invention as illustrated in the accompanying drawings.

### BRIEF DESCRIPTION OF THE DRAWINGS

FIG. 1 is a block diagram showing the structure of a guidance information retrieval apparatus in accordance with embodiment 1 of the present invention;

FIG. 2 is a diagram for explaining an outline of updating of guidance retrieval data which is carried out by the guidance information retrieval apparatus in accordance with embodiment 1 of the present invention;

FIG. 3 is a diagram showing the format of guidance retrieval data for use in the guidance information retrieval apparatus in accordance with embodiment 1 of the present invention;

FIGS. 4A and 4B are diagrams respectively showing the structures of category data and substance data contained in the guidance retrieval data shown in FIG. 3;

FIG. 5 is a diagram showing the format of update data for use in the guidance information retrieval apparatus in accordance with embodiment 1 of the present invention;

FIGS. 6A and 6B are diagrams respectively showing the structures of correction/additional category data and correction/additional substance data contained in the update data shown in FIG. 5;

FIG. 7 is a flow chart showing main processing performed by the guidance information retrieval apparatus in accordance with embodiment 1;

FIG. 8 is a flow chart showing an initial-screen display process which the guidance information retrieval apparatus performs during the main processing shown in FIG. 7;

FIG. 9 is a flow chart showing the details of a process of acquiring category data, which is shown in FIG. 8;

FIG. 10 is a flow chart showing the details of a category selection display process which the guidance information retrieval apparatus performs during the main processing shown in FIG. 7;

FIG. 11 is a flow chart showing the details of a substance data display process which the guidance information retrieval apparatus performs during the main processing shown in FIG. 7;

FIGS. 12A, 12B, and 12C are diagrams each showing an example of a screen display produced by the guidance information retrieval apparatus in accordance with embodiment 1 of the present invention;

FIG. 13 is a block diagram showing the structure of a guidance information retrieval apparatus in accordance with embodiment 2 of the present invention;

FIG. 14 is a flow chart showing a process of displaying information about a retrieval target on an on-screen map, which is performed by the guidance information retrieval apparatus in accordance with embodiment 2 of the present invention;

FIG. 15 is a diagram showing an example of a screen display produced during the display process performed by the guidance information retrieval apparatus in accordance with embodiment 2 of the present invention;

FIG. 16 is a diagram showing the structure of category data contained in guidance retrieval data for use in a guidance information retrieval apparatus in accordance with embodiment 3 of the present invention;

FIG. 17 is a diagram showing the format of update data for use in the guidance information retrieval apparatus in accordance with embodiment 3 of the present invention;

FIG. 18 is a diagram showing a concept behind a data updating process performed by a guidance information retrieval apparatus in accordance with embodiment 4 of the present invention;

FIG. 19 is a flow chart showing the data update process performed by the guidance information retrieval apparatus in accordance with embodiment 4 of the present invention;

FIG. 20 is a diagram schematically showing a general hierarchical structure of guidance retrieval data for used in a guidance information retrieval apparatus in accordance with embodiment 5 of the present invention;

FIG. 21 is a diagram showing the concrete structure of the guidance retrieval data for used in the guidance information retrieval apparatus in accordance with embodiment 5 of the present invention;

FIG. 22 is a diagram showing the concrete structure of guidance retrieval data for use in a guidance information retrieval apparatus in accordance with embodiment 6 of the present invention;

FIGS. 23A, 23B, and 23C are diagrams each showing an example of a message indicating that updating is carried out by the guidance information retrieval apparatus in accordance with embodiment 6 of the present invention;

FIG. 24 is a flow chart showing the details of a process of displaying substance data which a guidance information retrieval apparatus in accordance with embodiment 7 of the present invention performs during main processing;

FIG. 25 is a flow chart showing the details of a process of displaying information about a retrieval target on an on-screen map, which the guidance information retrieval apparatus in accordance with embodiment 7 of the present invention performs during the main processing;

FIG. 26 is a diagram showing an example of a screen display produced during the display process performed by the guidance information retrieval apparatus in accordance with embodiment 7 of the present invention;

FIG. 27 is a flow chart showing the details of a process of displaying substance data which a guidance information retrieval apparatus in accordance with embodiment 8 of the present invention during main processing;

FIG. 28 is a flow chart showing the details of a process of displaying information about a retrieval target on an on-screen map, which the guidance information retrieval apparatus in accordance with embodiment 8 of the present invention performs during the main processing;

FIGS. 29A and 29B are diagrams each showing an example of a screen display produced during the display process performed by the guidance information retrieval apparatus in accordance with embodiment 8 of the present invention;

FIG. 30 is a diagram showing a concept behind a data updating process performed by a guidance information retrieval apparatus in accordance with embodiment 9 of the present invention;

FIG. 31 is a block diagram showing the structure of a guidance information retrieval apparatus in accordance with embodiment 10 of the present invention;

FIG. 32 is a flow chart showing a process of acquiring category data, which is performed by the guidance information retrieval apparatus in accordance with embodiment 10 of the present invention;

FIG. 33 is a block diagram showing the structure of a guidance information retrieval apparatus in accordance with embodiment 11 of the present invention;

FIG. 34 is a block diagram showing the structure of a center apparatus for use in a guidance information retrieval system including the guidance information retrieval apparatus in accordance with embodiment 11 of the present invention;

FIG. 35 is a flow chart showing the operation of the guidance information retrieval apparatus shown in FIG. 33;

FIG. 36 is a flow chart showing the operation of the center apparatus shown in FIG. 34;

FIG. 37 is a block diagram showing the structure of a guidance information retrieval apparatus in accordance with embodiment 12 of the present invention;

FIG. 38 is a block diagram showing the structure of a center apparatus for use in a guidance information retrieval system including the guidance information retrieval apparatus in accordance with embodiment 12 of the present invention;

FIG. 39 is a flow chart showing the operation of the guidance information retrieval apparatus shown in FIG. 37; and

FIG. 40 is a flow chart the operation of the center apparatus shown in FIG. 38.

### DETAILED DESCRIPTION OF THE PREFERRED EMBODIMENTS

The preferred embodiment of the invention will now be described with reference to the accompanying drawings.

### Embodiment 1

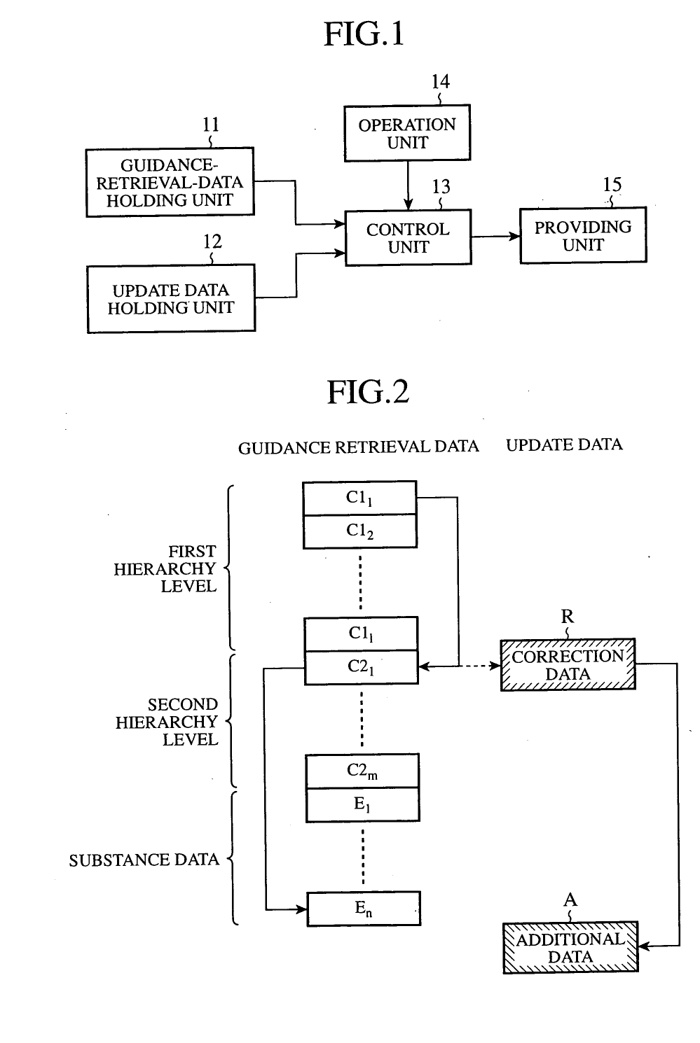

FIG. 1 is a block diagram showing the structure of a guidance information retrieval apparatus in accordance with embodiment 1 of the present invention. This guidance information retrieval apparatus is provided with a guidance retrieval data holding unit 11, an update data holding unit 12, a control unit 13, an operation unit 14, and a providing unit 15.

The guidance retrieval data holding unit 11 consists of, for example, a hard disk, and holds guidance retrieval data. The guidance retrieval data includes category data each indicating a category in which retrieval targets, such as facilities, are put, substance data each indicating the substance of a retrieval target, and soon. The details of these guidance retrieval data will be mentioned later. The guidance retrieval data currently being held by the guidance retrieval data holding unit 11 are read by the control unit 13. As the guidance retrieval data holding unit 11, one of various types of storage media can be used instead of a hard disk.

The update data holding unit 12 consists of a removable storage media, such as a CD (Compact Disc), a DVD (Digital Versatile Disk), or a memory card, and holds update data. The update data includes correction data each used for correcting guidance retrieval data, and additional data to be added to the guidance retrieval data. The details of the update data will be mentioned later. The update data currently being held by the update data holding unit 12 are read by the control unit 13.

The control unit 13 consists of, for example, a microcomputer, and performs guidance retrieval processing while updating the guidance retrieval data read from the guidance retrieval data holding unit 11 using the update data read from the update data holding unit 12 in response to an instruction from the operation unit 14. Thus, the guidance information retrieval apparatus in accordance with embodiment 1 of the present invention can carry out guidance retrieval based on the latest guidance retrieval data. Guidance retrieval information resulting from the guidance retrieval processing (which will be mentioned later in detail) by the control unit 13 is then sent to the providing unit 15.

The operation unit 14 consists of, for example, a touch panel, a pushbutton switch, etc., and is used by the user when he or she provides an instruction to the guidance information retrieval apparatus. An instruction which is produced by the operation unit 14 when the user operates the operation unit 14 is then sent to the control unit 13, as mentioned above.

The providing unit 15 consists of, for example, a display unit, and displays data sent from the control unit 13 so as to provide the data for the user. Instead of the display unit, an audio output device that outputs the data sent from the control unit 13 via voice can be used as the providing unit 15.

Next, the outline of the guidance retrieval processing performed by the guidance information retrieval apparatus which is so constituted as mentioned above will be explained with reference to FIG. 2.

The guidance retrieval data have a hierarchical structure in which category data are arranged in the form of two or more hierarchies and substance data are arranged in the form of the lowest hierarchy, and the format of the guidance retrieval data will be mentioned below in detail. The category data specify categories in which retrieval targets are put, respectively. The substance data specify the contents (i.e., attributes) of the retrieval targets, respectively. Category data at each level of the hierarchy are associated with either one or more category data at a lower level of the hierarchy or substance data at the lowest level of the hierarchy. Category data at a lower level of the hierarchy which is associated with one category data is referred to as “corresponding child category data” from here on, and substance data which is associated with one category data is referred to as “corresponding substance data” from here on.

The guidance retrieval data as illustrated in FIG. 2 includes category data C11 to C11 at the first level of the hierarchy which is the top of the hierarchy, category data C21 to C2m at the second level of the hierarchy, and substance data E1 to En at the lowest level of the hierarchy. The category data C21 at the second level of the hierarchy is one corresponding child category data associated with the category data C11 at the first level of the hierarchy. The substance data En at the lowest level of the hierarchy is one corresponding substance data associated with the category data C21 at the second level of the hierarchy.

The update data includes correction data R and additional data A, and the format of the update data will be mentioned below in detail. The correction data R consists of either correction category data used for correcting category data included in the guidance retrieval data or correction substance data used for correcting substance data included in the guidance retrieval data. The additional data A consists of additional category data used for adding new category data to the guidance retrieval data and/or additional substance data used for adding new substance data to the guidance retrieval data.

The correction data R as illustrated in FIG. 2 is correction category data used for correcting the category data C21 at the second level of the hierarchy of the guidance retrieval data. The additional data A illustrated in FIG. 2 is additional substance data which is added to the guidance retrieval data.

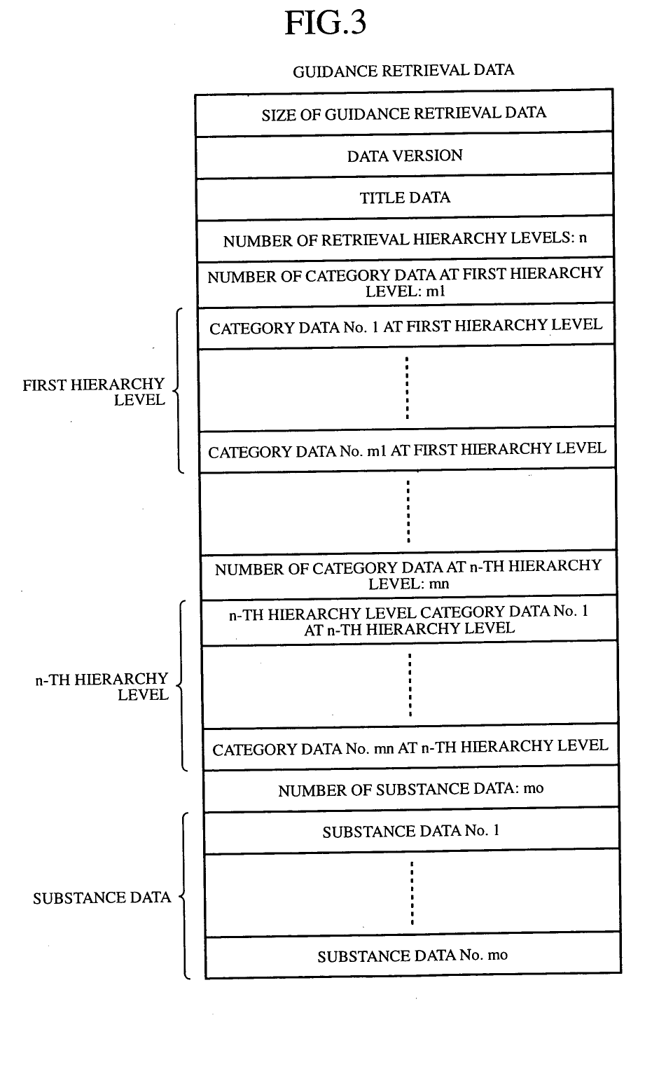

Next, the details of the guidance retrieval data will be explained. FIG. 3 shows the format of the guidance retrieval data. The guidance retrieval data can consist of “size of guidance retrieval data”, “data version”, “title data”, “number of retrieval levels of the hierarchy”, “number of category data” at each level of the hierarchy, “category data” at each level of the hierarchy, “number of substance data”, and “substance data.”

The size of the guidance retrieval data shows the size (i.e., the number of bytes) of the whole of the guidance retrieval data. The data version shows the version of the guidance retrieval data. The title data shows a title name given to the guidance retrieval data. The number of retrieval levels of the hierarchy shows the number of levels of the hierarchy of the guidance retrieval data. “Number of retrieval levels of the hierarchy: n” is defined as the number of retrieval levels of the hierarchy in the example shown in FIG. 3.

The number of category data is provided for every level of the hierarchy, and shows the number of category data included in each level of the hierarchy. “Number of category data at the first level of the hierarchy: m1, . . . , and number of category data at the n-th level of the hierarchy: mn” are defined as the number of category data at the first level of the hierarchy, . . . , and the number of category data at the n-th level of the hierarchy, respectively, in the example shown in FIG. 3.

One or more Category data are provided at each level of the hierarchy and show categories at each level of the hierarchy, respectively. In the example shown in FIG. 3, “category data No. 1 to No. m1 at the first level of the hierarchy” are defined as category data at the first level of the hierarchy, and “category data No. 1 to No. mn at the n-th level of the hierarchy “are defined as category data at the n-th level of the hierarchy.

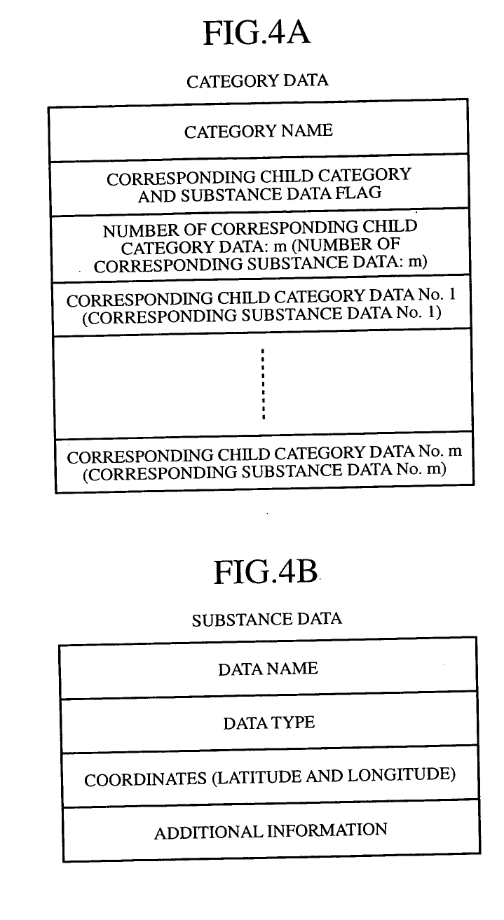

As shown in FIG. 4A, each category data includes “category name”, “corresponding child category and substance data flag”, “number of corresponding child category data (or number of corresponding substance data)”, and “corresponding child category data (or corresponding substance data).”

The category name is a name given to the category data concerned. The corresponding child category and substance data flag is a flag showing whether data at a lower level of the hierarchy associated with the category data concerned is category data or substance data. The number of corresponding child category data (or the number of corresponding substance category) shows the number of corresponding child category data when the data at a lower level of the hierarchy associated with the category data concerned is category data, and shows the number of corresponding substance category when the data at a lower level of the hierarchy associated with the category data concerned is substance data. The corresponding child category data (or the corresponding substance category) shows corresponding child category data when the data at a lower level of the hierarchy associated with the category data concerned is category data, and shows corresponding substance category when the data at a lower level of the hierarchy associated with the category data concerned is substance data.

The number of substance data shows the number of substance data at the lowest level of the hierarchy. “Number of substance data: mo” is defined as the number of substance data in the example shown in FIG. 3.

Each substance data shows the substance of a corresponding retrieval target. “Substance data No. 1 to No. mo” are defined as the substance data in the example shown in FIG. 3.

Each substance data includes “data name”, “data type”, “coordinates (latitude and longitude)”, and “additional information”, as shown in FIG. 4B. The data name is a name given to the substance data concerned, for example, a facility's name. The data type shows the type of the substance data concerned, i.e., the type of a corresponding retrieval target. The coordinates (latitude and longitude) show the position of the corresponding retrieval target represented by the substance data concerned. The additional information is information, such as the location of the corresponding retrieval target represented by the substance data concerned, a telephone number, business hours, business items, and so on.

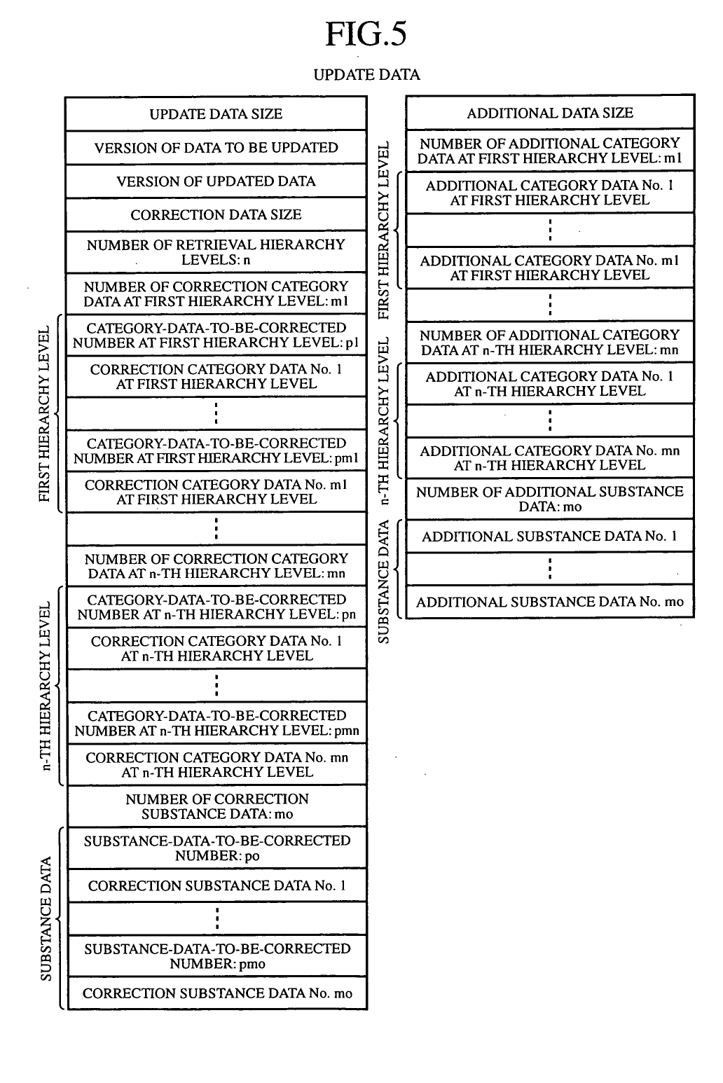

Next, the details of the update data will be explained. FIG. 5 shows the format of the update data. The update data can consist of “update data size”, “version of data to be updated”, “version of updated data”, “correction data size”, “number of retrieval levels of the hierarchy”, “number of correction category data” at each level of the hierarchy, “category-data-to-be-corrected number” at each level of the hierarchy, “correction category data” at each level of the hierarchy, “number of correction substance data”, “substance-data-to-be-corrected number”, “correction substance data”, “additional data size”, “number of additional category data” at each level of the hierarchy, “additional category data” at each level of the hierarchy, “number of additional substance data”, and “additional substance data.” The update data size shows the size (i.e., the number of bytes) of the whole of the update data. The version of data to be updated shows the version of the guidance retrieval data which is to be updated by using the update data concerned. The version of updated data shows the version of the guidance retrieval data which has been updated by using the update data concerned. The correction data size shows the size (i.e., the number of bytes) of the correction data contained in the update data. The number of retrieval levels of the hierarchy shows the number of levels of the hierarchy of the update data concerned. “Number of retrieval levels of the hierarchy: n” is defined as the number of retrieval levels of the hierarchy in the example shown in FIG. 5.

The number of correction category data is provided for each level of the hierarchy, and shows the number of correction category data included in each level of the hierarchy. “Number of correction category data at the first level of the hierarchy m1, . . . , and number of correction category data at the n-th level of the hierarchy: mn” are defined as the number of correction category data at the first level of the hierarchy, . . . , and the number of correction category data at the n-th level of the hierarchy, respectively, in the example shown in FIG. 5.

Each category-data-to-be-corrected number is a number given to category data included in the guidance retrieval data which is to be corrected. Each category data included in the guidance retrieval data which has a category-data-to-be-corrected number is to be corrected by using a corresponding correction category data located immediately after the category-data-to-be-corrected number. In the example shown in FIG. 5, “category-data-to-be-corrected number at the first level of the hierarchy: p1, . . . , and category-data-to-be-corrected number at the first level of the hierarchy: pm1” are defined as the numbers of category data to be corrected at the first level of the hierarchy, and “category-data-to-be-corrected number at the n-th level of the hierarchy: pn, . . . , and category-data-to-be-corrected number at the n-th level of the hierarchy: pmn” are defined as the numbers of category data to be corrected at the n-th level of the hierarchy.

Each correction category data is used in order to correct corresponding category data included in the guidance retrieval data. Which category data included in the guidance retrieval data by using each correction category data is specified by corresponding category-data-to-be-corrected number located immediately before each correction category data. In the example shown in FIG. 5, “correction category data at the first level of the hierarchy No. 1, . . . , and correction category data at the first level of the hierarchy No. m1” are defined as correction category data at the first level of the hierarchy, and “correction category data at the n-th level of the hierarchy No. 1, . . . , and correction category data at the n-th level of the hierarchy No. mn” are defined as correction category data at the n-th level of the hierarchy.

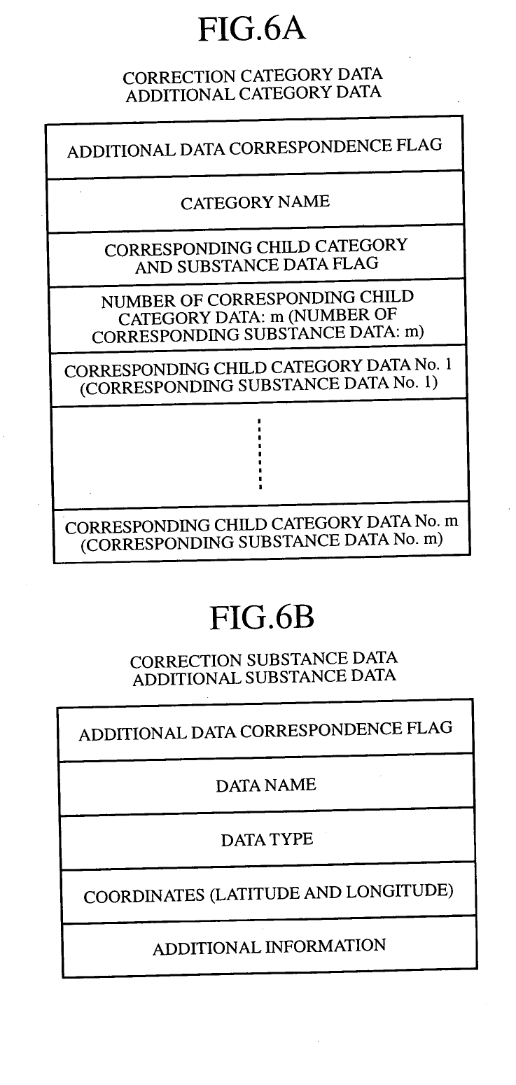

As shown in FIG. 6A, each correction category data includes “additional data correspondence flag”, “category name”, “corresponding child category and substance data flag”, “number of corresponding child category data (or number of corresponding substance category)”, and “corresponding child category data (corresponding substance category).”

The additional data correspondence flag is used in order to determine whether the correction category data concerned is correction category data or additional category data. According to this additional data correspondence flag, the correction category data concerned is used as either correction category data or additional category data. The corresponding child category and substance data flag indicates whether data at a lower level of the hierarchy associated with the corresponding category data is category data or substance data. The number of corresponding child category data (or the number of corresponding substance category) shows the number of corresponding child category data when the data at a lower level of the hierarchy associated with the corresponding category data is category data, and shows the number of corresponding substance category when the data at a lower level of the hierarchy associated with the corresponding category data is substance data. The corresponding child category data (or the corresponding substance category) shows corresponding child category data when the data at a lower level of the hierarchy associated with the corresponding category data is category data, and shows corresponding substance data when the data at a lower level of the hierarchy associated with the corresponding category data is substance data.

The number of correction substance data shows the number of correction substance data used for correcting the substance data at the lowest level of the hierarchy of the guidance retrieval data. “Number of correction substance data: mo” is defined as the number of correction substance data in the example shown in FIG. 5.

Each substance-data-to-be-corrected number is a number given to substance data included in the guidance retrieval data which is to be corrected. Each substance data included in the guidance retrieval data which has a substance-data-to-be-corrected number is to be corrected by using a corresponding correction substance data located immediately after the substance-data-to-be-corrected number. “Substance-data-to-be-corrected numbers: p0 to pmo” are defined as the numbers of substance data to be corrected in the example shown in FIG. 5.

Each correction substance data shows correction substance data used for correcting corresponding substance data and placed at the lowest level of the hierarchy. “Correction substance data No. 1 to No. mo” are defined as correction substance data in the example shown in FIG. 5.

Each correction substance data includes “additional data correspondence flag”, “data name”, “data type”, “coordinates (latitude and longitude)”, and “additional information”, as shown in FIG. 6B. The additional data correspondence flag is a flag for determining whether the correction substance data concerned is correction substance data or additional substance data. According to this additional data correspondence flag, the correction substance data concerned is used as either correction substance data or additional substance data. The data name, the data type, the coordinates (latitude and longitude), and the additional information are the same as them explained with reference to FIG. 4B.

The additional data size shows the size (i.e., the number of bytes) of the additional data contained in the update data. The number of additional category data is provided for each level of the hierarchy of the update data, and shows the number of additional category data at each level of the hierarchy. In the example shown in FIG. 5, “number of additional category data at the first level of the hierarchy: m1, . . . , and number of additional category data at the n-th level of the hierarchy: mn” are defined as the number of additional category data at the first level of the hierarchy, . . . , and the number of additional category data at the n-th level of the hierarchy, respectively.

Each additional category data is category data to be added to the existing guidance retrieval data. The format of each additional category data is the same as each correction category data shown in FIG. 6A, and whether each additional category data is correction category data or additional category data is determined according to the corresponding additional data correspondence flag.

In the example shown in FIG. 5, “additional category data No. 1 at the first level of the hierarchy, . . . , and additional category data No. m1 at the first level of the hierarchy” are defined as additional category data at the first level of the hierarchy, and “additional category data No. 1 at the n-th level of the hierarchy, . . . , and additional category data No. mn at the n-th level of the hierarchy” are defined as additional category data at the n-th level of the hierarchy.

The number of additional substance data is the number of substance data to be added to the guidance retrieval data. “Number of additional substance data: mo” is defined as the number of additional substance data in the example shown in FIG. 5.

Each additional substance data is substance data to be added to the existing guidance retrieval data. The format of each additional substance data is the same as each correction substance data shown in FIG. 6B, and whether each additional substance data is correction substance data or additional substance data is determined by the corresponding additional data correspondence flag. “Additional substance data No. 1, . . . , and additional substance data No. mo” are defined as additional substance data in the example shown in FIG. 5.

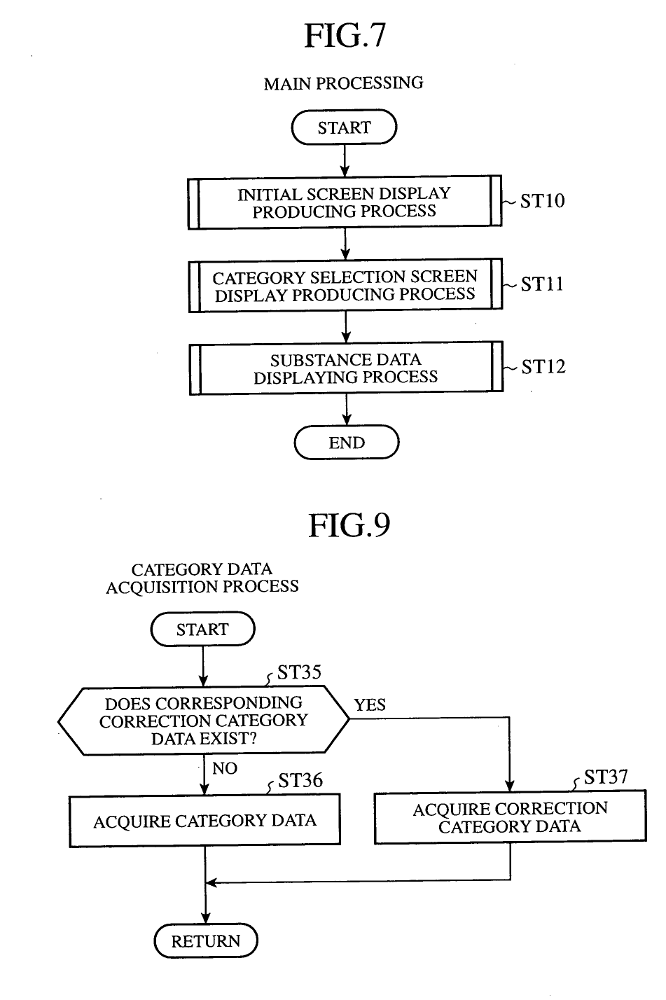

Next, the operation of the guidance information retrieval apparatus in accordance with embodiment 1 of the present invention constructed as mentioned above will be explained with reference to flow charts shown in FIGS. 7 to 11 by taking, as an example, a case where the guidance information retrieval apparatus searches for restaurants which are set as a retrieval target.

FIG. 7 is a flow chart showing main processing of the guidance retrieval processing which is carried out by the guidance information retrieval apparatus. This main processing is started in response to an instruction for starting guidance retrieval from the operation unit 14.

When an instruction of starting guidance retrieval is provided from the operation unit 14, an initial screen display process is carried out first (in step ST10). In this initial screen display process, a process of displaying an initial screen based on the category data at the first level of the hierarchy included in the guidance retrieval data is carried out, as will be mentioned later in detail.

A process of producing a category selection screen display is then carried out (in step ST11). In this category selection screen display producing process, a category selection screen display for allowing the user to select a category in which the retrieval target is put is produced based on category data at the second and lower levels of the hierarchy included in the guidance retrieval data, as will be mentioned later in detail.

A process of displaying substance data is then carried out (in step ST12). In this substance data display process, retrieval results are displayed based on the substance data, as will be mentioned later in detail.

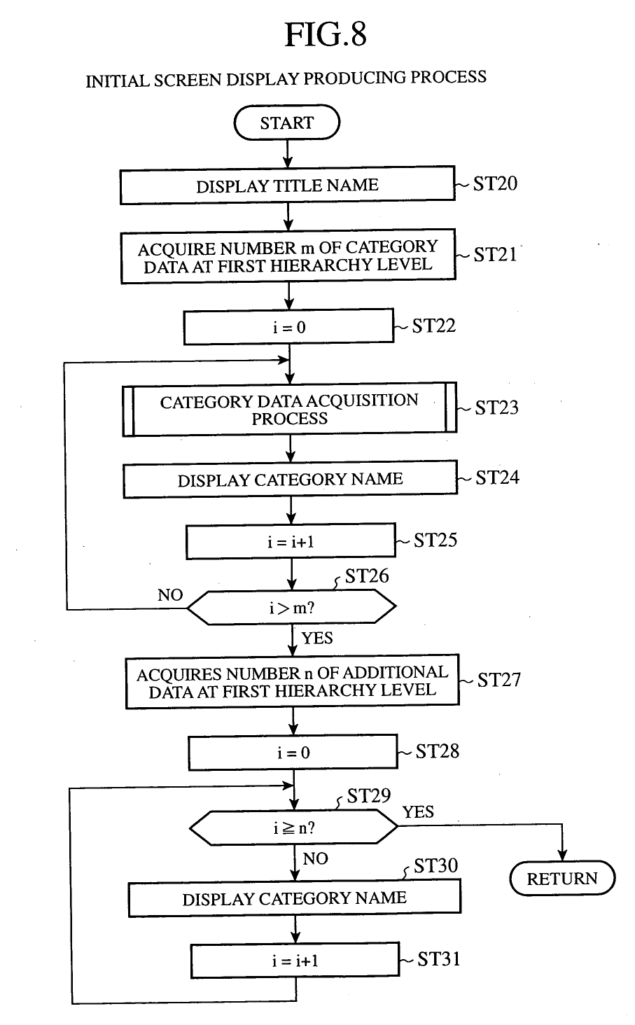

Next, the details of the initial screen display process performed in step ST10 of the main processing shown in FIG. 7 will be explained with reference to flow charts shown in FIGS. 8 and 9.

In the initial screen display process, a display of a title name specified by corresponding title data included in the guidance retrieval data is carried out first (in step ST20). In other words, the control unit 13 captures the guidance retrieval data from the guidance retrieval data holding unit 11 in response to an instruction for starting guidance retrieval from the operation unit 14. The control unit 13 then sends corresponding title data contained in the guidance retrieval data to the providing unit 15. As a result, a title name is displayed on the providing unit 15.

The control unit 13 then acquires the number of category data m at the first level of the hierarchy (in step ST21). In other words, the control unit 13 captures the guidance retrieval data from the guidance retrieval data holding unit 11, and acquires the number of category data m at the first level of the hierarchy contained in the guidance retrieval data. The control unit 13 then initializes the contents i of a loop counter used for the control unit 13 to acquire category data to zero (in step ST22).

A process of acquiring category data is then carried out (in step ST23). The details of this category data acquisition process will be explained with reference to the flow chart shown in FIG. 9. In the category data acquisition process, the control unit 13 checks to see whether correction category data corresponding to the i-th category data at the first level of the hierarchy exists in the correction data of the update data captured from the update data holding unit 12 first (in step ST35). When then determining that no correction category data corresponding to the i-th category data at the first level of the hierarchy exists in the correction data of the update data, the control unit 13 acquires the i-th category data at the first level of the hierarchy included in the guidance retrieval data (in step ST36). After that, the control unit 13 returns the sequence to the main processing. On the other hand, when determining that correction category data corresponding to the i-th category data at the first level of the hierarchy exists in the correction data of the update data, the control unit 13 acquires the correction category data corresponding to the i-th category data at the first level of the hierarchy from the correction data included in the update data (in step ST27). After that, the control unit 13 returns the sequence to the main processing.

In the main processing, the control unit 13 then causes the providing unit 15 to display a corresponding category name (in step ST24). In other words, when acquiring category data in step ST23, the control unit 13 sends a category name (refer to FIG. 4A) contained in the category data to the providing unit 15 so as to cause it to display the category name, while when acquiring correction category data in step ST23, the control unit 13 sends a category name (refer to FIG. 6A) contained in the correction category data to the providing unit 15 so as to cause it to display the category name.

The control unit 13 then increments the contents i of the loop counter by only 1 (in step ST25). The control unit 13 checks to see whether or not the contents i of the loop counter are larger than the number m of category data at the first level of the hierarchy (in step ST26). When, in this step ST26, determining that i is not larger than m, the control unit returns the sequence to step ST23 in which it repeatedly performs the above-mentioned processes of steps ST23 to ST26.

When, in step ST26, determining that i is larger than m while repeatedly performing the processes of steps ST23 to ST26, the control unit 13 acquires the number n of additional category data at the first level of the hierarchy (in step ST27). The control unit 13 then initializes the contents i of a loop counter used for acquiring additional category data to zero (in step ST28). The control unit 13 checks to see whether or not the contents i of the loop counter are larger than the number n of additional category data at the first level of the hierarchy (in step ST29). When, in this step, determining that i is not larger than n, the control unit 13 causes the providing unit to display a corresponding category name (in step ST30). In other words, the control unit 13 causes the providing unit to display a category name (refer to FIG. 6A) contained in the additional category data at the first level of the hierarchy, which is included in the additional data of the update data. The control unit 13 then increments the contents i of the loop counter by only 1 (in step ST31). After that, the control unit 13 returns the sequence to step ST29 and then repeatedly performs the processes of steps ST29 to ST31.

When, in step ST29, determining that i is larger than n while repeatedly performing the above-mentioned steps ST29 to ST31 the control unit 13 further determines that the acquisition of all additional category data is completed and then returns the sequence to the main processing.

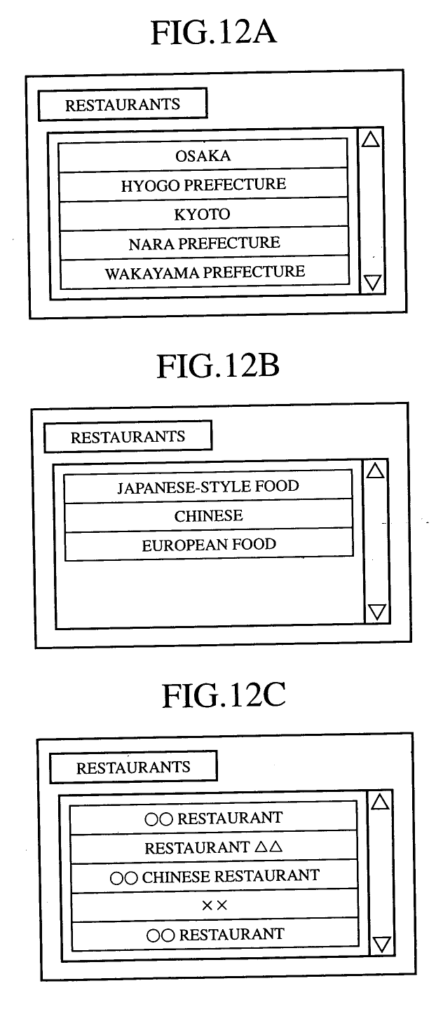

By performing the initial screen display processing as previously explained, the control unit 13 causes the providing unit 15 to display the initial screen, as shown in FIG. 12A, including the title name: ” Restaurants” and two or more “Prefecture names” respectively showing categories at the first level of the hierarchy. The user can thus continue searching for desired restaurants by specifying either of the two or more prefecture names displayed in this initial screen.

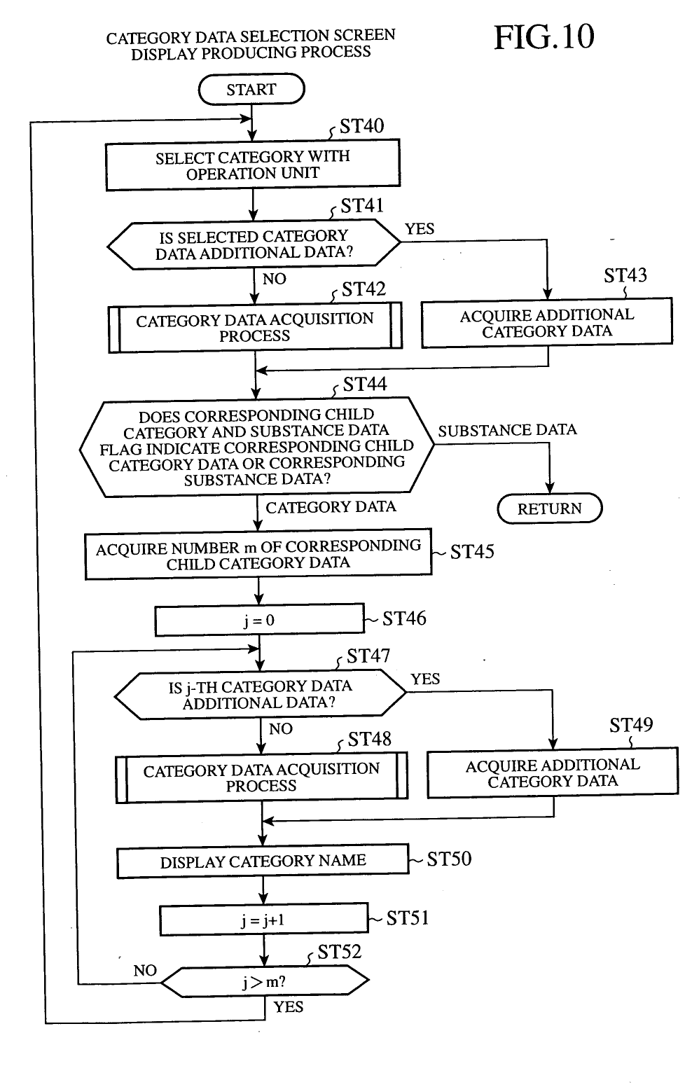

Next, the details of the category selection display producing process performed in step ST11 of the main processing as shown in FIG. 7 will be explained with reference to a flow chart shown in FIG. 10.

This category selection display producing processing is started when the user selects one of the two or more categories displayed by the providing unit 15 by using the operation unit 14 (e.g., one of the two or more prefecture names as shown in FIG. 12A when the two or more prefecture names are displayed in the initial screen) (in step ST40). When the category selection display producing processing is started, the control unit 13 checks to see whether or not the selected category data is additional data first (in step ST41). The control unit 13 checks to see whether or not the selected category data is additional data by determining whether the selected category data's number is larger than the number of category data included in the guidance retrieval data. When, in this step ST41, determining that the selected category data is not additional data (i.e., when determining that the selected category data's number is equal to or smaller than the number of category data), the control unit 13 performs a process of acquiring corresponding category data (in step ST42). In this category data acquisition processing (refer to FIG. 9), when determining that corresponding correction category data exists in the update data currently being held by the update data holding unit 12, the control unit 13 acquires the corresponding correction category data from the update data, whereas when determining that no corresponding correction category data exists in the update data, the control unit acquires the corresponding category data from the guidance retrieval data. After that, the control unit 13 advances the sequence to step ST44.

On the other hand, in the above-mentioned step ST41, when determining that the selected category data is additional data (i.e., when determining that the selected category data's number is larger than the number of category data included in the guidance retrieval data), the control unit 13 acquires additional category data (in step ST43). In other words, the control unit 13 acquires corresponding additional category data from the additional data included in the update data. After that, the control unit 13 advances the sequence to step ST44.

In step ST44, by checking the corresponding child category and substance data flag, the control unit 13 determines whether either the category data or correction category data acquired in step ST42 or data associated with the additional category data acquired in step ST43 is corresponding child category data or corresponding substance category. When, in this step ST44, determining that either the category data or correction category data acquired in step ST42 or the data associated with the additional category data acquired in step ST43 is corresponding substance category, the control unit 13 returns the sequence to the main processing and then advances to a process of displaying substance data (in step ST11).

On the other hand, when, in step ST44, determining that either the category data or correction category data acquired in step ST42 or the-data associated with the additional category data acquired in step ST43 is corresponding child category data, the control unit 13 acquires the number m of category data at a level of the hierarchy in which the corresponding child category data is put from the guidance retrieval data (in step ST45). The control unit 13 then initializes the contents j of a loop counter used in order to acquire category data to zero (in step ST46). The control unit 13 further checks to see whether or not the j-th category data at the level of the hierarchy in which the corresponding child category data is put is additional data (in step ST47). To this end, the control unit 13 checks to see whether or not the j-th category data's number is larger than the number m of category data.

When, in this step ST47, determining that the j-th category data at the level of the hierarchy in which the corresponding child category data is put is not additional data, that is, when determining that the j-th category data's number is equal to or smaller than the number m of category data, the control unit 13 performs a process of acquiring category data (in step ST48). In this category data acquisition processing (refer to FIG. 9), when determining that corresponding correction category data exists in the update data currently being held by the update data holding means 12, the control unit 13 acquires the corresponding correction category data from the update data, whereas when determining that no corresponding correction category data exists in the update data, the control unit 13 acquires the corresponding category data from the guidance retrieval data. After that, the control unit 13 advances the sequence to step ST50.

On the other hand, when, in above-mentioned step ST47, determining that the j-th category data at the level of the hierarchy in which the corresponding child category data is put is additional data, that is, when determining that the j-th category data's number is larger than the number m of category data, the control unit 13 perform a process of acquiring additional category data (in step ST49). In other words, the control unit 13 acquires additional category data from the (j−m+1)-th additional data included in the update data. After that, the control unit 13 advances the sequence to step ST50.

In step ST50, the control unit 13 displays a corresponding category name. In other words, when, in step ST48, acquiring category data, the control unit 13 displays a category name (refer to FIG. 4A) contained in the category data. When, in step ST48, acquiring correction category data, the control unit 13 displays a category name (refer to FIG. 6A) contained in the correction category data. When, in step ST49, acquiring additional category data, the control unit 13 displays a category name (refer to FIG. 6A) contained in the additional category data.

The control unit 13 then increments the contents j of the loop counter by only 1 (in step ST51). The control unit 13 then checks to see whether or not the contents j of the loop counter are larger than the number m of category data at the level of the hierarchy in which the corresponding child category data is put (in step ST52). When, in this step ST52, determining that j is not larger than m, the control unit 13 returns the sequence to step ST47 and repeatedly performs the processes of steps ST47 to ST52.

When, in step ST52, determining that j is larger than m while repeatedly performing the above-mentioned steps ST47 to ST52, the control unit 13 further determines that the processing on category data at the level of the hierarchy in which the corresponding child category data is put is completed and then returns the sequence to step ST40. In this case, when the user further, in step ST40, selects either of the categories displayed on the providing unit 15 by way of the operation unit 14, the control unit 13 restarts the category selection display producing processing.

When carrying out the above-mentioned category selection display producing processing, the control unit 13 can display both a title name: “Restaurants” and two or more “Types of meal” which are categories at a lower level of the hierarchy than the first level of the hierarchy on the providing unit 15, as shown in FIG. 12B.

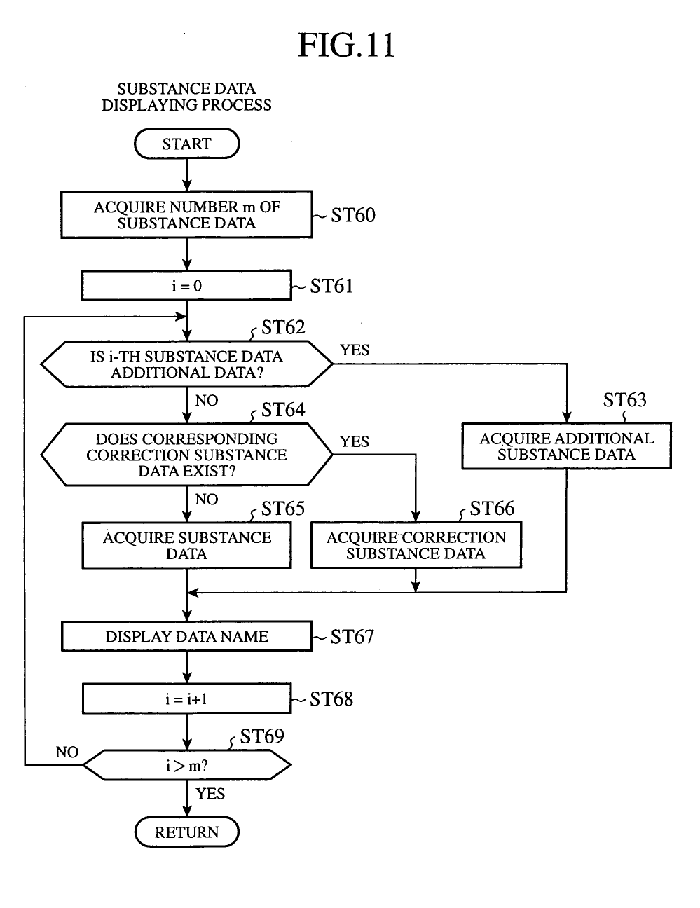

Next, the details of the substance data display processing performed in step ST12 of the main processing shown in FIG. 7 will be explained with reference to a flow chart shown in FIG. 11.

In the substance data display processing, the control unit 13 performs acquisition of the number m of substance data first (in step ST60). In other words, the control unit 13 retrieves the guidance retrieval data from the guidance retrieval data holding unit 11 so as to acquire the number m of substance data contained in the guidance retrieval data. The control unit 13 then initializes the contents i of a loop counter used in order to acquire substance data to zero (in step ST61).

The control unit 13 further checks to see whether or not the i-th substance data is additional data (in step ST62). To this end, the control unit 13 checks to see whether or not the i-th substance data's number is larger than the number m of substance data included in the guidance retrieval data. When, in this step ST62, determines that the i-th substance data is additional data, that is, the i-th substance data's number is larger than the number m of substance data, the control unit 13 carries out acquisition of the additional substance data (in step ST63). In other words, the control unit acquires the (i−m+1)-th additional substance data from the additional data included in the update data. After that, the control unit advances the sequence to step ST67.

When, in above-mentioned step ST62, determining that the i-th substance data is not additional data, that is, when determining that the i-th substance data's number is equal to or smaller than the number m of substance data, the control unit 13 further checks to see whether correction substance data corresponding to the i-th substance data exists in the correction data of the update data (in step ST64). When then determining that no correction substance data corresponding to the i-th substance data exists in the correction data of the update data, the control unit 13 acquires the i-th substance data from the guidance retrieval data (in step ST65). After that, the control unit advances the sequence to step ST67. On the other hand, when determining that correction substance data corresponding to the i-th substance data exists in the correction data of the update data, the control unit 13 acquires the correction substance data from the update data (in step ST66). After that, the control unit 13 advances the sequence to step ST67.

In step ST67, the control unit 13 displays a corresponding data name. In other words, when, in step ST65, acquiring substance data, the control unit 13 displays a data name (refer to FIG. 4B) contained in the substance data. When, in step ST66, acquiring correction substance data, the control unit 13 displays a data name (refer to FIG. 6B) contained in the correction substance data. When, in step ST66, acquiring additional substance data, the control unit 13 displays a data name (refer to FIG. 6B) contained in the additional substance data.

The control unit 13 then increments the contents i of the loop counter by only 1 (in step ST68). The control unit 13 also checks to see whether or not the contents i of the loop counter are larger than the number m of substance data (in step ST69). When, in this step ST69, determining that i is not larger than m, the control unit 13 returns the sequence to step ST62 and repeatedly performs the processes of steps ST62 to ST69. When, in step ST69, determining that i is larger than m while repeatedly performing the above-mentioned steps ST62 to ST69, the control unit 13 determines that the processing on all substance data is completed and then returns the sequence to the main processing.

Through the above-mentioned substance data display processing, restaurant names which are final results of the guidance retrieval can be displayed on the providing unit 15, as shown in FIG. 12C.

As previously explained, the guidance information retrieval apparatus according to this embodiment 1 stores update data, which are used for correcting the existing guidance retrieval data currently being held by the guidance retrieval data holding unit 11 or adding data to the guidance retrieval data, in the update data holding unit 12, and, in response to an instruction for performing guidance retrieval from the operation unit 14, performs guidance retrieval processing while referring to both the guidance retrieval data and the update data. Therefore, even when the guidance retrieval data are updated, the guidance information retrieval apparatus need not to rewrite the guidance retrieval data. The guidance information retrieval apparatus can thus search through the latest guidance information for desired retrieval targets without rewriting the existing guidance retrieval data.

### Embodiment 2

A guidance information retrieval apparatus in accordance with embodiment 2 of the present invention displays a retrieval target obtained through guidance retrieval processing performed thereby on an on-screen map.

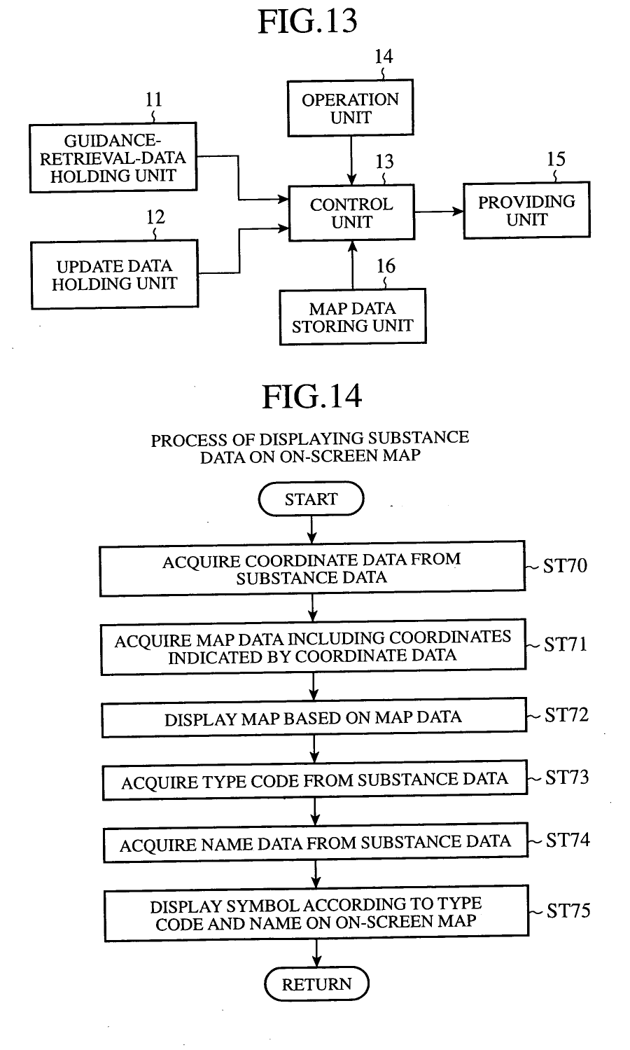

FIG. 13 is a block diagram showing the structure of the guidance information retrieval apparatus in accordance with embodiment 2 of the present invention. The guidance information retrieval apparatus according to this embodiment is equivalent to the one in which a map data storing unit 16 is added to the guidance information retrieval apparatus in accordance with above-mentioned embodiment 1.

The map data storing unit 16 stores map data required for displaying a map on a providing unit 15. Map data stored in this map data storing unit 16 are read by a control unit 13.

Next, the operation of the guidance information retrieval apparatus in accordance with embodiment 2 of the present invention will be explained. This guidance information retrieval apparatus performs a process of displaying information about a retrieval target on an on-screen map after performing a process of displaying substance data (in step ST12) of the main processing shown in FIG. 7.

FIG. 14 is a flow chart showing the process of displaying information about a retrieval target on an on-screen map. The process of displaying information about a retrieval target on an on-screen map is started when the user selects the retrieval target from two or more retrieval targets which the control unit has displayed on the providing unit 15 through the substance data display processing (in step ST12 of FIG. 7) by using an operation unit 14. In the process of displaying information about a retrieval target on an on-screen map, the control unit 13 acquires coordinate data from corresponding substance data or the like first (in step ST70). In other words, the control unit 13 acquires coordinate data showing the coordinates of the selected retrieval target from substance data, correction substance data, or additional substance data, which corresponds to the retrieval target which the user has selected by using the operation unit 14.

The control unit 13 then acquires map data including the coordinates of the retrieval target specified by the coordinate data (i.e., latitude and longitude data) acquired in step ST70 (in step ST71). In other words, the control unit 13 sends the coordinate data to the map data storing unit 16. In response to this coordinate data, the map data storing unit 16 then sends map data about a map of a predetermined area having a center at the latitude and longitude specified by the coordinate data to the control unit 13.

The control unit 13 then displays a corresponding map on the providing unit 15 (in step ST72). In other words, the control unit 13 generates map drawing data based on the map data received from the map data storing unit 16 and sends the map drawing data to the providing unit 15. As a result, a map having a center at the latitude and longitude specified by the coordinate data is displayed on the providing unit 15.

The control unit 13 then acquires a type code from the substance data (in step ST73). In other words, the control unit 13 acquires a type code showing a data type from the substance data, the correction substance data, or the additional substance data which corresponds to the retrieval target which the user has selected by using the operation unit 14. The control unit 13 then acquires name data from the substance data or the like (in step ST74). In other words, the control unit 13 acquires name data indicating a data name from the substance data, the correction substance data, or the additional substance data which corresponds to the retrieval target which the user has selected by using the operation unit 14.

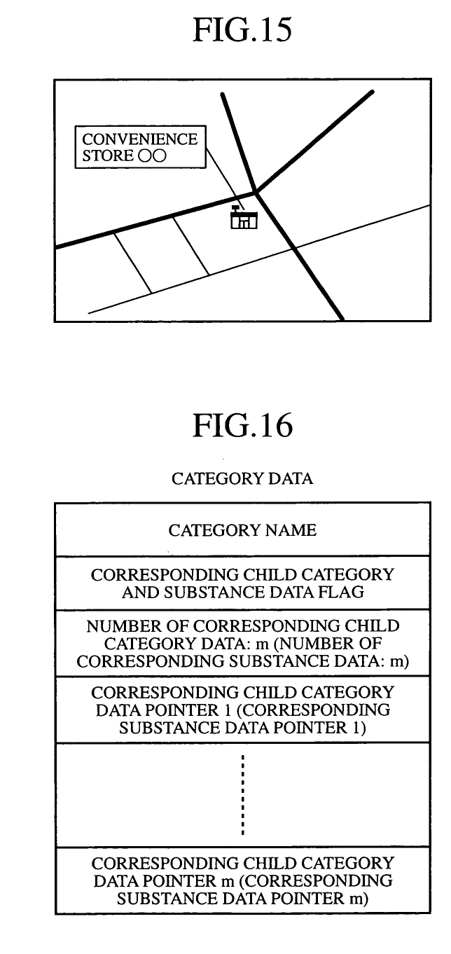

The control unit 13 then displays both a graphic symbol according to the type code acquired in step ST73 and a name according to the name data acquired in step ST74 on the map displayed, in step ST72, on the providing unit 15 (instep ST75). The control unit 13 thus displays the graphic symbol showing the retrieval target and the name of the retrieval target (e.g., ◯◯ convenience store) on the on-screen map, as shown in FIG. 15.

As previously explained, the guidance information retrieval apparatus according to embodiment 2 of the present invention can display the location of a retrieval target which the user has selected, as well as a graphic symbol indicating the retrieval target and the retrieval target's name, on the providing unit 15. Therefore, the convenience of the guidance information retrieval apparatus can be improved.

The guidance information retrieval apparatus according to above-mentioned embodiment 2 is so constructed as to display both the result of the guidance retrieval as shown in FIG. 12A and the location of the retrieval target on the map as shown in FIG. 15 on split parts of the screen of the providing unit 15, respectively. As an alternative, the guidance information retrieval apparatus can be so constructed as to display them on a single screen side by side. Embodiment 3.

In a guidance information retrieval apparatus in accordance with embodiment 3 of the present invention, the format of data current being held by a guidance retrieval data holding unit 11 and the format of data currently being held by an update data holding unit 12 differ from those of above-mentioned embodiment 1.

While the format of guidance retrieval data for use in the guidance information retrieval apparatus according to this embodiment 3 is the same as that of the guidance retrieval data for use in the guidance information retrieval apparatus in accordance with embodiment 1 shown in FIG. 3, the formats of category data and update data contained in the guidance retrieval data differ from those of the guidance information retrieval apparatus in accordance with embodiment 1.

FIG. 16 shows the structure of the category data contained in the guidance retrieval data for use in the guidance information retrieval apparatus in accordance with embodiment 3. Each category data according to this embodiment includes “corresponding child category data pointers (or corresponding substance category pointers)” instead of “corresponding child category data (or corresponding substance category)” shown in FIG. 4A. Each corresponding child category data pointer (or corresponding substance category pointer) is a corresponding child category data pointer when data at a lower level of the hierarchy are category data, and is a corresponding substance category pointer when the data at the lower level of the hierarchy are substance data.

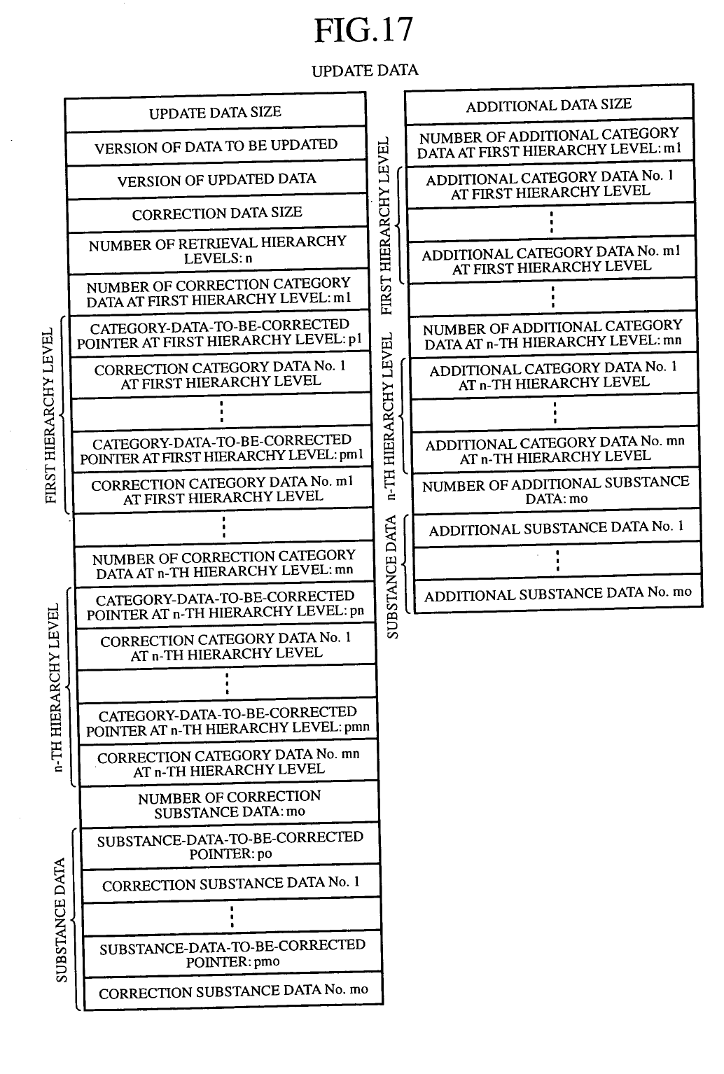

FIG. 17 shows the format of the update data for use in the guidance information retrieval apparatus in accordance with embodiment 3. The update data include “category-data-to-be-corrected pointers” instead of “category-data-to-be-corrected numbers” shown in FIG. 5, and include “substance-data-to-be-corrected pointers” instead of “substance-data-to-be-corrected numbers” shown in FIG. 5.

Each category-data-to-be-corrected pointer is a number specifying category data included in the guidance retrieval data which is to be corrected. The category data included in the guidance retrieval data specified by each category-data-to-be-corrected pointer is to be corrected by using corresponding correction category data located immediately after the category-data-to-be-corrected pointer. In the example shown in FIG. 17, “category-data-to-be-corrected pointers pointing category data at the first level of the hierarchy: p1, . . . , and pm1” are defined as pointers pointing category data to be corrected at the first level of the hierarchy, and “category-data-to-be-corrected pointers pointing category data at the n-th level of the hierarchy: pn, . . . , and pmn” are defined as pointers pointing category data to be corrected at the n-th level of the hierarchy

Each substance-data-to-be-corrected pointer is a number specifying substance data included in the guidance retrieval data which is to be corrected. The substance data included in the guidance retrieval data specified by each substance-data-to-be-corrected pointer is corrected by using corresponding correction substance data located immediately after the substance-data-to-be-corrected pointer. In the example shown in FIG. 17, “substance-data-to-be-corrected pointers p0, . . . , and pmo” are defined as pointers pointing substance data to be corrected.

In the guidance information retrieval apparatus in accordance with embodiment 2 of the present invention to which the guidance retrieval data and the update data having the formats mentioned above are applied, when either category data at a lower level of the hierarchy or substance data, which is associated with category data selected, is displayed while category selection display producing processing is carried out, the control unit 13 can directly acquire corresponding child category data and corresponding child substance data specified by pointers without carrying out comparison between a number given to the category or substance data and the number of category or substance data included in the guidance retrieval data. Illustration of a detailed flow of the processing is omitted.

When correcting the guidance retrieval data by using correction data, the control unit 13 can directly acquire category or substance data to be corrected from positions specified by pointers without carrying out comparison between a number given to the category or substance data and the number of category or substance data included in the guidance retrieval data.

As previously explained, the guidance information retrieval apparatus according to this embodiment 3 is so constructed as to directly specify either category data or substance data at a lower level of the hierarchy with pointers. The guidance information retrieval apparatus can thus achieve a speedup in the guidance retrieval processing.

### Embodiment 4

A guidance information retrieval apparatus in accordance with embodiment 4 of the present invention is so constructed as to add additional data contained in update data to the tail end of guidance retrieval data so as to record the additional data therein.

The structure of this guidance information retrieval apparatus is the same as that of the guidance information retrieval apparatus in accordance with above-mentioned embodiment 1 shown in FIG. 1. A rewritable storage medium such as a hard disk is used as a guidance retrieval data holding unit 11. A removable storage media, such as a CD or a DVD, is used as an update data holding unit 12.

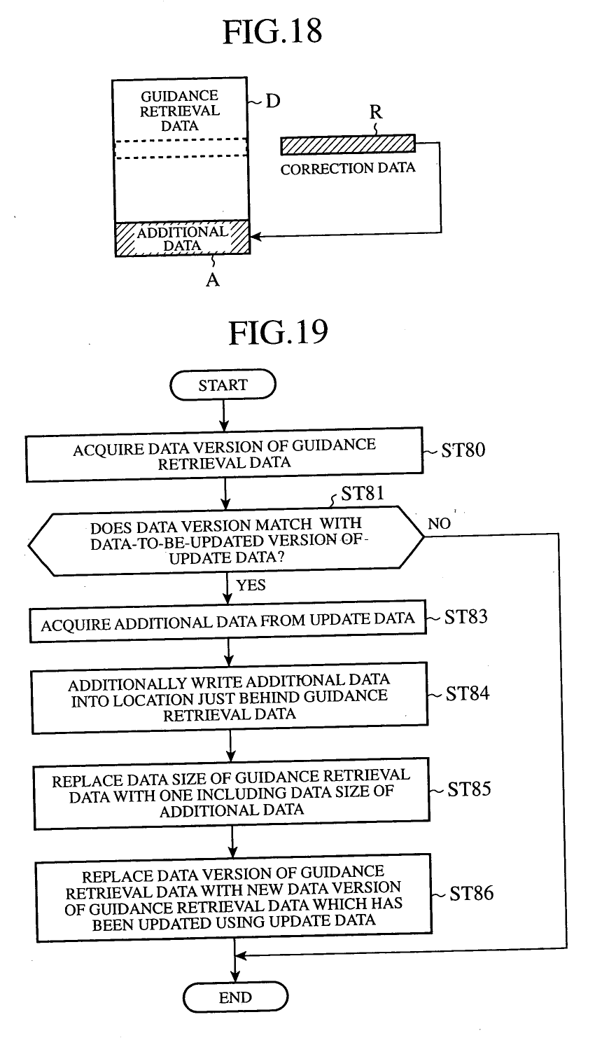

FIG. 18 is a diagram showing a concept behind a data updating process performed by the guidance information retrieval apparatus in accordance with embodiment 4 of the present invention. In this guidance information retrieval apparatus, additional data A contained in the update data currently being held by the update data holding unit 12 is added to the tail end of guidance retrieval data D currently being held by the guidance retrieval data holding unit 11. Therefore, after the data updating process is completed, guidance information retrieval processing is performed using both the guidance retrieval data currently being held by the guidance retrieval data holding unit 11, to which additional data are added, and correction data currently being held by the update data holding unit 12.

Next, the data updating process performed by the guidance information retrieval apparatus according to this embodiment 4 of the present invention will be explained with reference to a flow chart shown in FIG. 19.

In the data updating processing, a control unit 13 acquires the version of the guidance retrieval data first (in step ST80). In other words, the control unit 13 reads the guidance retrieval data from the guidance retrieval data holding unit 11, and acquires information indicating the data version contained in these read guidance retrieval data. The control unit 13 then checks to see whether the data version of the guidance retrieval data agrees with a data-to-be-updated version of the update data (in step ST81). In other words, the control unit 13 reads the update data from the update data holding unit 12, and acquires information indicating the data-to-be-updated version contained in this read update data. The control unit 13 then compares the data-to-be-updated version with the data version acquired in step ST80.

When, in this step ST81, determining that the data version of the guidance retrieval data does not agree with the data-to-be-updated version contained in the read update data, the control unit 13 determines that the update data cannot be used for updating of the guidance retrieval data and then ends the data updating processing. On the other hand, when determining that the data version of the guidance retrieval data agrees with the data-to-be-updated version contained in the read update data, the control unit 13 acquires the additional data A from the update data (in step ST82). In other words, the control unit 13 acquires the additional data A contained in the update data from the update data read, in step ST81, from the update data holding unit 12.

The control unit 13 then writes the additional data at a location behind the guidance retrieval data (in step ST84). In other words, the control unit 13 writes the additional data A acquired in step ST83 into a location behind the tail end of the guidance retrieval data D stored in the guidance retrieval data holding unit 11. The control unit 13 then replaces the data size of the guidance retrieval data with a new one including the data size of the additional data (in step ST85). In other words, the control unit 13 adds the size of all data contained in the guidance retrieval data, and the size of the additional data of the update data, and writes the addition result as the data size of the guidance retrieval data in the guidance retrieval data holding unit 11.

The control unit 13 then replaces the data version of the guidance retrieval data with a new data version of the guidance retrieval data which has been updated using the update data (in step ST86). In other words, the control unit 13 retrieves the new data version of the guidance retrieval data which has been updated using the update data, and writes it, as the data version of the guidance retrieval data, in the guidance retrieval data holding unit 11. The control unit 13 thus completes the data updating processing.

After the data updating processing is completed, the control unit 13 acquires the additional data from the guidance retrieval data holding unit 11 and performs guidance retrieval processing, instead of acquiring the additional data from the update data holding unit 12.

As previously explained, the guidance information retrieval apparatus in accordance with embodiment 4 of the present invention stores additional data in the guidance retrieval data holding unit 11. Therefore, the guidance information retrieval apparatus can access the additional data in the same way that it accesses the guidance retrieval data stored therein. As a result, the efficiency of development of software used for effecting the operation of the guidance information retrieval apparatus can be improved.

### Embodiment 5

A guidance information retrieval apparatus in accordance with embodiment 5 of the present invention is so constructed as to update guidance retrieval data in units of categories of facility types.

The structure of the guidance information retrieval apparatus in accordance with embodiment 5 of the present invention is the same as that of the guidance information retrieval apparatus in accordance with embodiment 1 shown in FIG. 1.

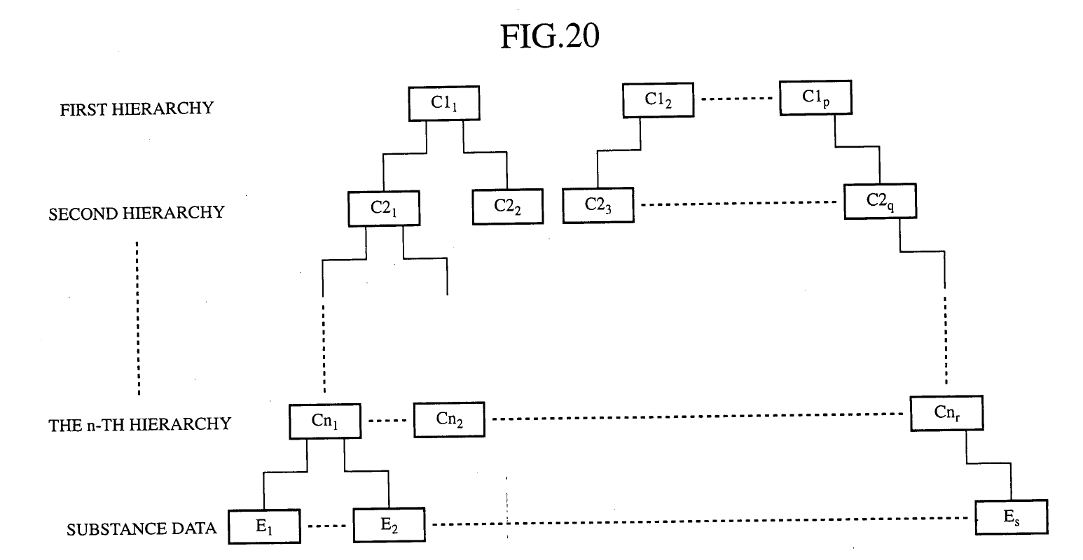

FIG. 20 is a diagram schematically showing a general hierarchical structure of guidance retrieval data for use in the guidance information retrieval apparatus in accordance with embodiment 5 of the present invention. The first level of the hierarchy of the guidance retrieval data includes category data C1₁, C1₂, . . . , and C1ₚ. The second level of the hierarchy includes category data C2₁, C2₂, . . . , and C1_{q}. The n-th level of the hierarchy includes category data Cn₁, Cn₂, . . . , and Cnᵣ. The lowest level of the hierarchy includes substance data E₁, E₂, . . . , and Eₛ.

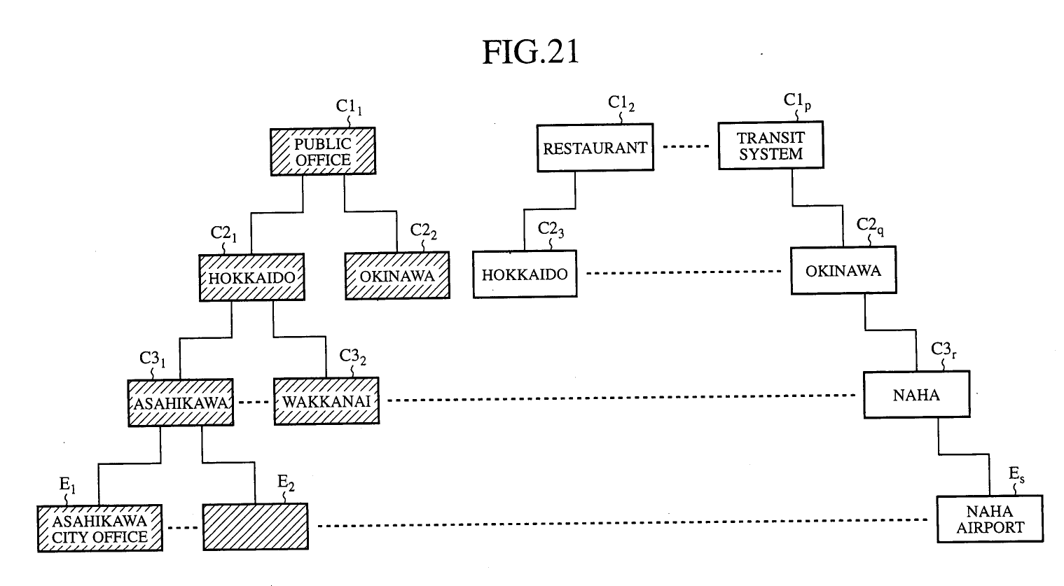

As concretely shown in FIG. 21, the guidance retrieval data for use in the guidance information retrieval apparatus according to this embodiment 5 has the first level of the hierarchy in which categories of facility types, such as “public office”, “restaurant”, and “transit system” are provided, the second level of the hierarchy in which categories of prefectures of Japan, such as “Hokkaido” and “Okinawa”, are provided for each facility type category at the first level of the hierarchy, the third level of the hierarchy in which categories of cities, towns and villages, such as “Asahikawa” and “Wakkanai”, are provided for each prefecture category at the second level of the hierarchy, and the lowest level of the hierarchy in which names showing the substances of retrieval targets, such as “Asahikawa city office” and “Naha airport”, are provided.

The updating of the guidance retrieval data constructed as mentioned above is performed in units of facility type categories. Hatched portions shown in FIG. 21 correspond to ranges to be updated when “public office” is selected as a target facility type category to be updated.

As previously explained, when updating only data associated with a category of a certain facility type, the guidance information retrieval apparatus in accordance with embodiment 5 of the present invention can partially update only category or substance data at each level of the hierarchy associated with the category of the certain facility type. Therefore, since only required update data, i.e., update data put in a facility type category which is a target for updating is all that is needed to update the guidance retrieval data, the quantity of the update data can be reduced. Since the quantity of the update data can be reduced, the time required for the updating of the guidance retrieval data can be reduced.

### Embodiment 6

The guidance information retrieval apparatus in accordance with embodiment 6 of the present invention is so constructed as to update guidance retrieval data in units of categories of prefectures of Japan.

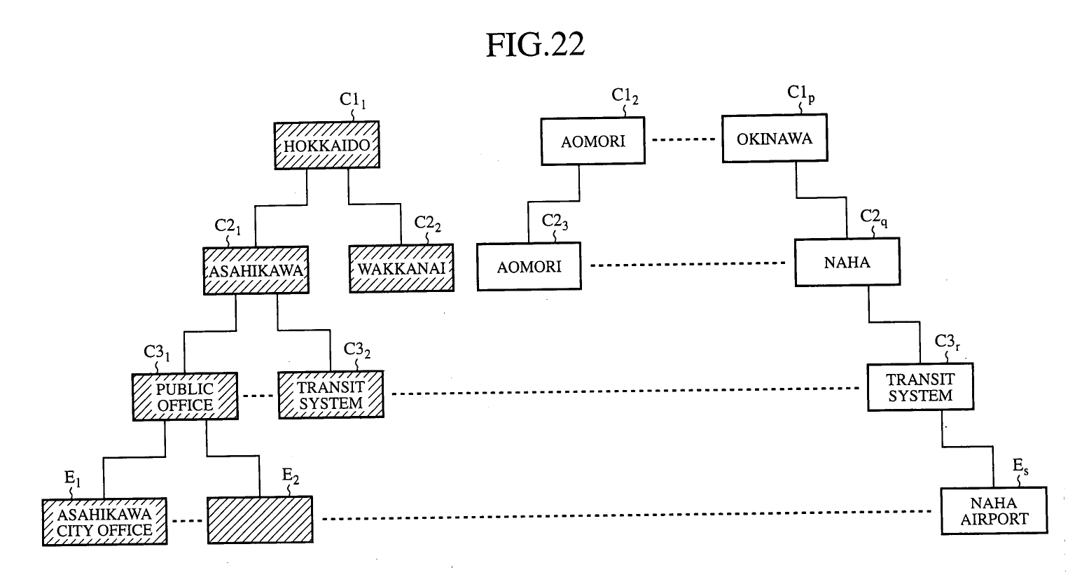

Also in the guidance information retrieval apparatus in accordance with embodiment 6 of the present invention, guidance retrieval data having a hierarchical structure as shown in FIG. 20 are used. As shown in FIG. 22, these guidance retrieval data include the first level of the hierarchy in which categories of prefectures, such as “Hokkaido”, “Aomori”, and “Okinawa”, are provided, the categories of prefectures being an example of categories of areas of the present invention, the second level of the hierarchy in which categories of cities, towns and villages, such as “Asahikawa”, “Wakkanai”, “Aomori”, and “Naha”, are provided for each prefecture category at the first level of the hierarchy, the third level of the hierarchy in which categories of types, such as “public office” and “transit system”, are provided for each city, town or village category at the second level of the hierarchy, and the lowest level of the hierarchy in which the substances of retrieval targets, such as “Asahikawa city office” and “Naha airport” are provided.

The updating of the guidance retrieval data constructed as mentioned above is carried out in units of the categories of prefectures of Japan. Hatched portions shown in FIG. 22 correspond to ranges to be updated when “Hokkaido” is selected as a target category of prefectures to be updated.

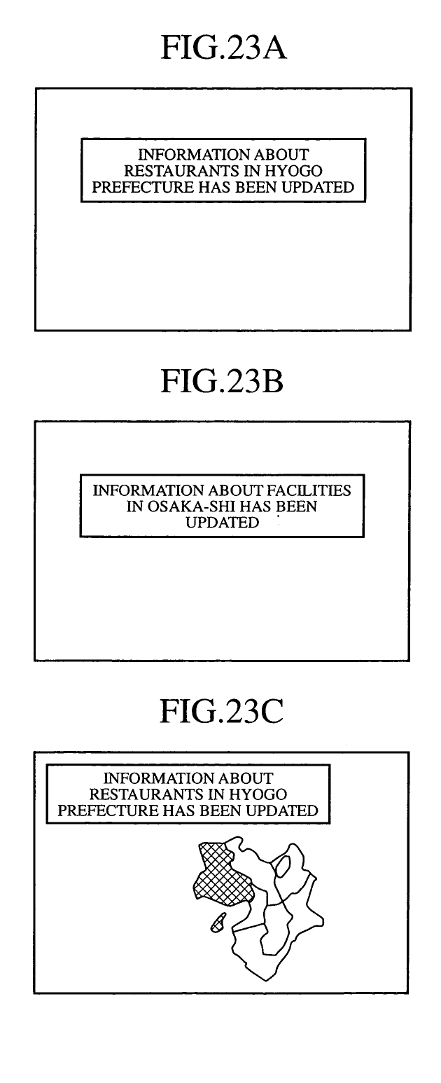

When the updating of the guidance retrieval data is carried out, the guidance information retrieval apparatus according to this embodiment 6 displays information indicating the updating on the providing unit 15 so as to notify the updating to the user. As shown in FIG. 23A, the guidance information retrieval apparatus can provide notification of the updating of the guidance retrieval data to the user by displaying a message, such as “Updating of information about restaurants in Hyogo Prefecture has been made”, on the providing unit 15. The guidance information retrieval apparatus can alternatively provide notification of the updating of the guidance retrieval data to the user by displaying a message, such as “Updating of information about facilities in Osaka city has been made” on the providing unit 15, as shown in FIG. 23B. The guidance information retrieval apparatus can alternatively provide notification of the updating of the guidance retrieval data to the user by displaying a message, such as “Updating of information about restaurants in Hyogo Prefecture has been made”, as well as map data indicating the position of Hyogo Prefecture, on the providing unit 15, as shown in FIG. 23C.

As previously explained, when only updating a category of a certain prefecture of Japan, the guidance information retrieval apparatus according to embodiment 6 of the present invention partially updates only category data at each level of the hierarchy or substance data associated with the category of the certain prefecture of Japan. Therefore, since only required update data, i.e., update data put in a category of a certain prefecture of Japan which is a target for updating is all that is needed to update the guidance retrieval data, the quantity of the update data can be reduced. Since the quantity of the update data can be reduced, the time required for the updating of the guidance retrieval data can be reduced.

In addition, the guidance information retrieval apparatus according to embodiment 6 of the present invention can provide update data for the user in units of categories of prefectures of Japan. Therefore, the user can determine whether updating of guidance retrieval about which area in Japan can be carried out, and therefore can make the guidance information retrieval apparatus update only guidance retrieval data about a desired area.

### Embodiment 7

A guidance information retrieval apparatus in accordance with embodiment 7 of the present invention is so constructed as to provide yet-to-be updated guidance retrieval and updated guidance retrieval data after updating the guidance retrieval data using update data,

The structure of the guidance information retrieval apparatus in accordance with embodiment 7 of the present invention is the same as that of the guidance information retrieval apparatus in accordance with embodiment 2 shown in FIG. 13.

Next, the operation of the guidance information retrieval apparatus in accordance with embodiment 7 of the present invention will be explained. The guidance information retrieval apparatus of this embodiment 7 performs processes of displaying substance data and displaying information about a retrieval target on an on-screen map during execution of main processing in a way different the way the guidance information retrieval apparatus of embodiment 2 performs the processes of displaying substance data and displaying information about a retrieval target on a non-screen map. Only a difference between embodiment 7 and embodiment 2 will be explained hereafter.

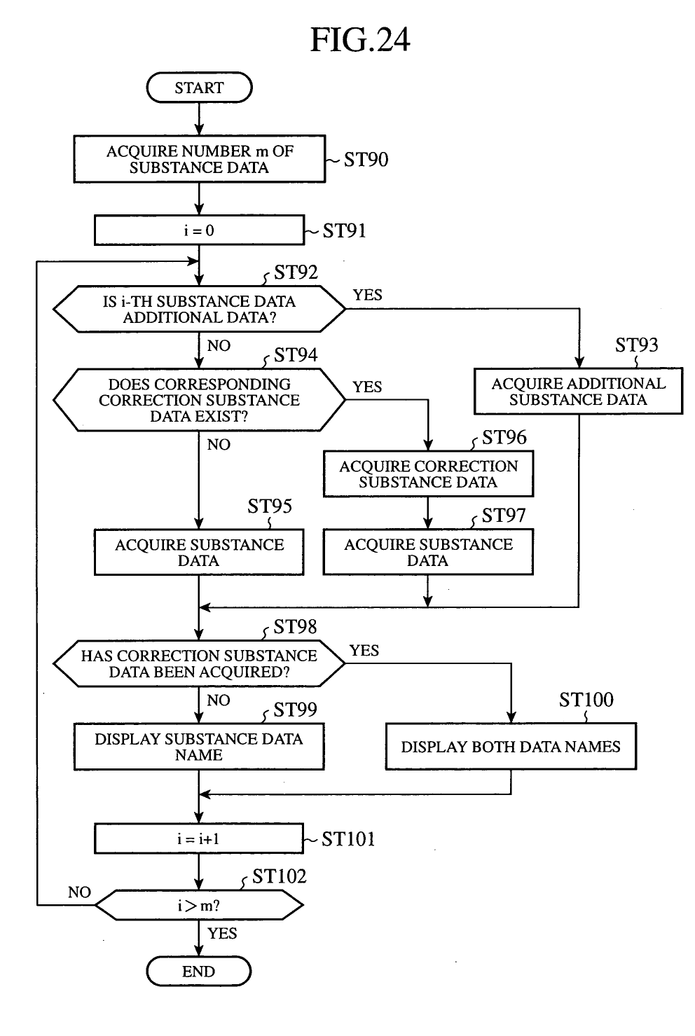

FIG. 24 is a flow chart showing the details of the process of displaying substance data performed in step ST12 of the main processing shown in FIG. 7.

In the substance data display process, a control unit 13 acquires the number m of substance data first (in step ST90). In other words, the control unit 13 retrieves the guidance retrieval data from a guidance retrieval data holding unit 11 so as to acquire the number m of substance data contained in the guidance retrieval data. The control unit 13 then initializes the contents i of a loop counter used in order to acquire substance data to zero (in step ST91).

The control unit 13 further checks to see whether or not the i-th substance data is additional data (in step ST92). To this end, the control unit checks to see whether or not the i-th substance data's number is larger than the number m of substance data included in the guidance retrieval data. When, in this step ST92, determining that the i-th substance data is additional data, that is, the i-th substance data's number is larger than the number m of substance data, the control unit 13 carries out acquisition of the additional substance data (in step ST93). In other words, the control unit 13 acquires the (i−m+1)-th additional substance data from the additional data included in the update data. After that, the control unit 13 advances the sequence to step ST98.

When, in the above-mentioned step ST92, determining that the i-th substance data is not additional data, that is, when determining that the i-th substance data's number is equal to or smaller than the number m of substance data, the control unit 13 further checks to see whether correction substance data corresponding to the i-th substance data exists in the correction data of the update data (in step ST94). When then determining that no correction substance data corresponding to the i-th substance data exists in the correction data of the update data, the control unit 13 acquires the i-th substance data from the guidance retrieval data (in step ST95). After that, the control unit 13 advances the sequence to step ST98. On the other hand, when determining that correction substance data corresponding to the i-th substance data exists in the correction data of the update data, the control unit 13 acquires the correction substance data from the update data (in step ST96). The control unit 13 then acquires the i-th substance data from the guidance retrieval data (in step ST97). After that, the control unit 13 advances the sequence to step ST98.

The control unit 13, in step ST98, checks to see whether it has acquired correction substance data. When the control unit 13, in this step ST98, determines that it has not acquired correction substance data, it displays the substance data's name on a providing unit (in step ST99). To be more specific, the control unit 13 displays either a data name (refer to FIG. 4B) contained in the substance data acquired in step ST95 or a data name (refer to FIG. 6B) contained in the additional substance data acquired in step ST93 on the providing unit. On the other hand, when the control unit 13, in step ST98, determines that it has acquired correction substance data, it displays both data names (in step ST100). In other words, the control unit displays the data name (refer to FIG. 6B) contained in the correction substance data acquired in step ST96, and the data name (refer to FIG. 4B) contained in the substance data acquired in step ST97.

The control unit 13 then increments the contents i of the loop counter by only 1 (in step ST101). The control unit 13 then checks to see whether or not the contents i of the loop counter are larger than the number m of substance data (in step ST102). When, in this step ST102, determining that i is not larger than m, the control unit 13 returns the sequence to step ST92 and repeatedly performs the processes of steps ST92 to ST102.

When, in step ST102, determining that i is larger than m while repeatedly performing the above-mentioned steps ST92 to ST102, the control unit 13 determines that the processing on all substance data is completed and then returns the sequence to the main processing. Through the above-mentioned substance data display processing, final results of the guidance retrieval can be displayed on the providing unit 15.

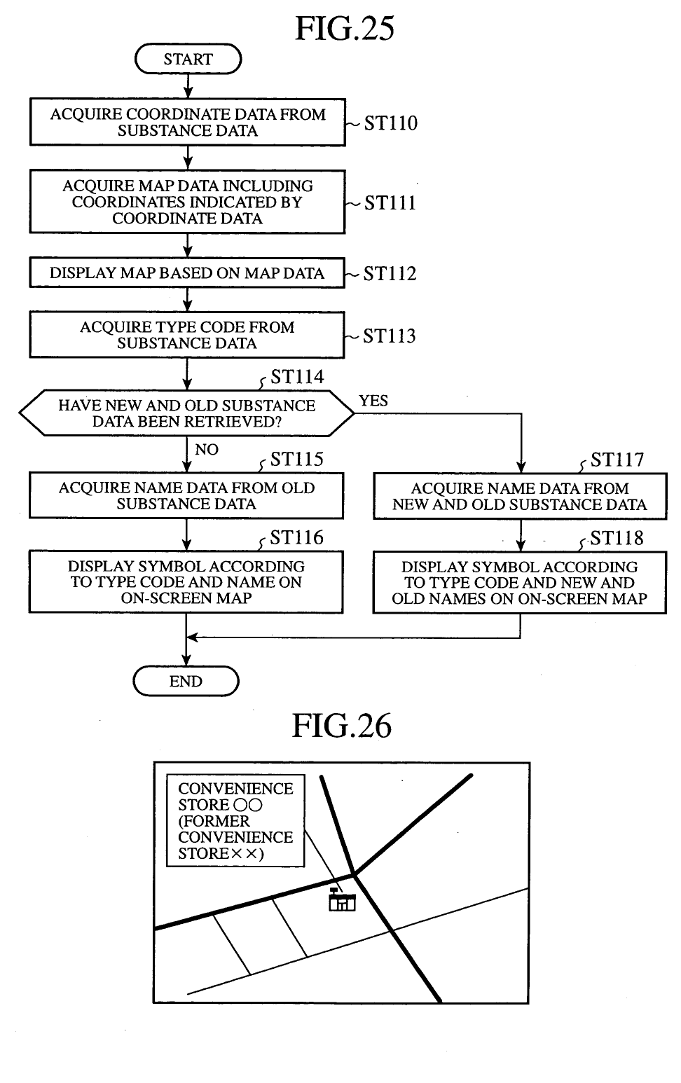

In the main processing, a process of displaying information about a retrieval target on an on-screen map is then performed. The details of the process of displaying information about a retrieval target on an on-screen map will be explained with reference to a flow chart shown in FIG. 25.

The process of displaying information about a retrieval target on an on-screen map is started when the user selects a retrieval target from two or more retrieval targets which the control unit has displayed on the providing unit 15 through the substance data display processing (in step ST12 of FIG. 7) by using an operation unit 14. In the process of displaying the retrieval target on an on-screen map, the control unit 13 acquires coordinate data from corresponding substance data or the like first (in step ST110). In other words, the control unit 13 acquires coordinate data showing the coordinates of the retrieval target from the substance data, correction substance data, or additional substance data, which corresponds to the retrieval target which the user has selected by using the operation unit 14.

The control unit 13 then acquires map data including the coordinates of the retrieval target specified by the coordinate data (i.e., latitude and longitude data) acquired in step ST110 (in step ST111). In other words, the control unit 13 sends the coordinate data to a map data storing unit 16. In response to this coordinate data, the map data storing unit 16 sends map data about a map of a predetermined area having a center at the latitude and longitude specified by the coordinate data to the control unit 13.

The control unit then displays a corresponding map on the providing unit 15 (in step ST112). In other words, the control unit 13 generates map drawing data based on the map data received from the map data storing unit 16 and sends the map drawing data to the providing unit 15. As a result, a map having a center at the latitude and longitude specified by the coordinate data is displayed on the providing unit 15.

The control unit 13 then acquires a type code from the substance data (in step ST113). In other words, the control unit 13 acquires a type code showing a data type from the substance data, the correction substance data, or the additional substance data which corresponds to the retrieval target which the user has selected by using the operation unit 14. The control unit 13 then checks to see whether it has retrieved both the old and new data (in step ST114). To be more specific, the control unit 13 checks to see whether it has performed acquisition (in step ST96) of the correction substance data, and acquisition (in step ST97) of the substance data through the substance data display processing shown in FIG. 24.

When the control unit 13, in this step ST114, determines that it has not retrieved both the old and new data, it then acquires name data from the substance data or the like (in step ST115). In other words, the control unit 13 acquires name data showing a data name from the substance data, the correction substance data, or the additional substance data which corresponds to the retrieval target which the user has selected by using the operation unit 14.

The control unit 13 then displays both a graphic symbol according to the type code acquired in step ST113 and a name according to the name data acquired in step ST115 on the map, instep ST112, displayed on the providing unit 15 (in step ST116). The control unit 13 thus displays the graphic symbol showing the retrieval target and the name of the retrieval target (e.g., ◯◯ convenience store) on the on-screen map, as shown in FIG. 15.

When the control unit 13, in above-mentioned step ST114, determines that it has retrieved both the old and new data, it then acquires both name data from the new substance data and name data from the old substance data (in step ST117). In other words, the control unit 13 acquires name data showing a data name from the substance data (i.e., the old data) which corresponds to the retrieval target which the user has selected by using the operation unit 14, and also acquires name data showing a data name from the correction substance data (i.e., the new data).

The control unit 13 then displays both a graphic symbol according to the type code acquired in step ST113, and old and new names according to the name data acquired from the old and new substance data in step ST117 on the map, in step ST112, displayed on the providing unit 15 (in step ST118). The control unit 13 thus displays both the graphic symbol showing the retrieval target, and the new name of the retrieval target (e.g., ◯◯ convenience store) and the old name of the retrieval target (e.g., XX convenience store) on the on-screen map, as shown in FIG. 26.

As previously explained, the guidance information retrieval apparatus in accordance with embodiment 7 of the present invention displays the position of a retrieval target which the user has selected, as well as with a graphic symbol showing the retrieval target and the new and old names of the retrieval target, on the providing unit 15. Therefore, any user who knows only yet-to-be updated information about a desired retrieval target can conveniently use the guidance information retrieval apparatus. The convenience of the guidance information retrieval apparatus can be improved.

### Embodiment 8

A guidance information retrieval apparatus in accordance with embodiment 8 of the present invention is so constructed as to, after updating guidance retrieval data using update data, display that the updating of the guidance retrieval data has been carried out.

The structure of the guidance information retrieval apparatus in accordance with embodiment 8 of the present invention is the same as that of the guidance information retrieval apparatus in accordance with embodiment 2 shown in FIG. 13.

Next, the operation of the guidance information retrieval apparatus in accordance with embodiment 8 of the present invention will be explained. The guidance information retrieval apparatus of this embodiment performs processes of displaying substance data and displaying information about a retrieval target on an on-screen map during execution of main processing in a way different the way the guidance information retrieval apparatus of embodiment 2 performs the processes of displaying substance data and displaying information about a retrieval target on anon-screen map. Only a difference between embodiment 8 and embodiment 2 will be explained hereafter.

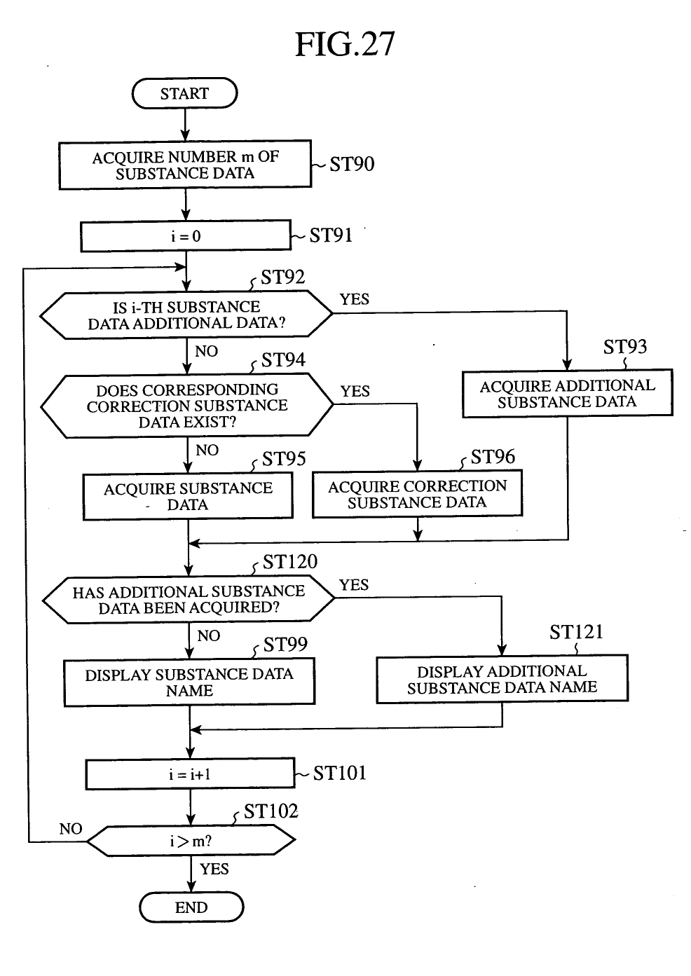

FIG. 27 is a flow chart showing the details of the process of displaying substance data performed in step ST12 of the main processing shown in FIG. 7. Since the substance data display processing of the guidance information retrieval apparatus of this embodiment partially differs from that of embodiment 7, the same steps as those shown in the flow chart of FIG. 24 or like steps are designated by the same reference symbols and the explanation of the substance data display processing will be made briefly.

In the substance data display processing, a control unit 13 acquires the number m of substance data included in the guidance retrieval data first (in step ST90). The control unit 13 then initializes the contents i of a loop counter used in order to acquire substance data to zero (in step ST91). The control unit 13 further checks to see whether or not the i-th substance data is additional data (in step ST92). When, in this step ST92, determining that the i-th substance data is additional data, the control unit 13 carries out acquisition of the additional substance data (in step ST93). After that, the control unit 13 advances the sequence to step ST120.

When, in above-mentioned step ST92, determining that the i-th substance data is not additional data, the control unit 13 checks to see whether correction substance data corresponding to the i-th substance data exists in the correction data of the update data (in step ST94). When then determining that no correction substance data corresponding to the i-th substance data exists in the correction data of the update data, the control unit 13 acquires the i-th substance data from the guidance retrieval data (in step ST95). After that, the control unit 13 advances the sequence to step ST120. On the other hand, when determining that correction substance data corresponding to the i-th substance data exists in the correction data of the update data, the control unit 13 acquires the correction substance data from the update data (in step ST96). After that, the control unit 13 advances the sequence to step ST120.

The control unit 13, in step ST120, checks to see whether it has acquired additional substance data. When the control unit 13, in this step ST120, determines that it has not acquired additional substance data, it displays the substance data's name on a providing unit (in step ST99). To be more specific, the control unit 13 displays either a data name (refer to FIG. 4B) contained in the substance data acquired in step ST95 or a data name (refer to FIG. 6B) contained in the correction substance data acquired in step ST96 on the providing unit. On the other hand, when the control unit 13, in step ST120, determines that it has acquired additional substance data, it displays the additional substance data's name on the providing unit with an additional symbol indicating that the additional substance data's name is based on the additional data being added to the additional substance data's name (in step ST121). In other words, the control unit 13 displays the data name (refer to FIG. 6B) contained in the additional substance data acquired in step ST93 on the providing unit with the additional symbol being added to the data name.

The control unit 13 then increments the contents i of the loop counter by only 1 (in step ST101). The control unit 13 also checks to see whether or not the contents i of the loop counter are larger than the number m of substance data (in step ST102). When, in this step ST102, determining that i is not larger than m, the control unit 13 returns the sequence to step ST92 and repeatedly performs the processes of steps ST92 to ST102.

When, in step ST102, determining that i is larger than m while repeatedly performing the above-mentioned steps ST92 to ST102, the control unit 13 further determines that the processing on all substance data is completed and then returns the sequence to the main processing.

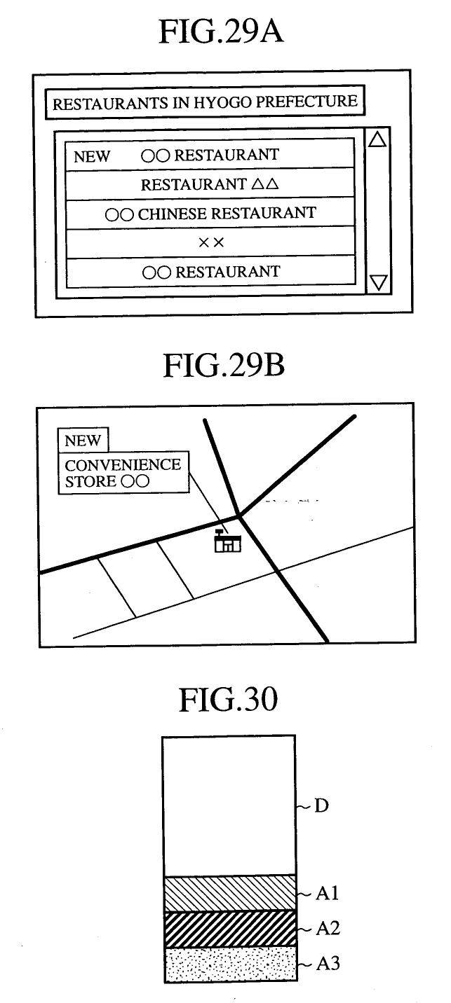

Through the above-mentioned substance data display processing, final results of the guidance retrieval, as shown in FIG. 29A, can be displayed on the providing unit 15. In FIG. 29A, “New” which is an additional symbol is attached to “◯◯ restaurant” which is the name of an added retrieval target.

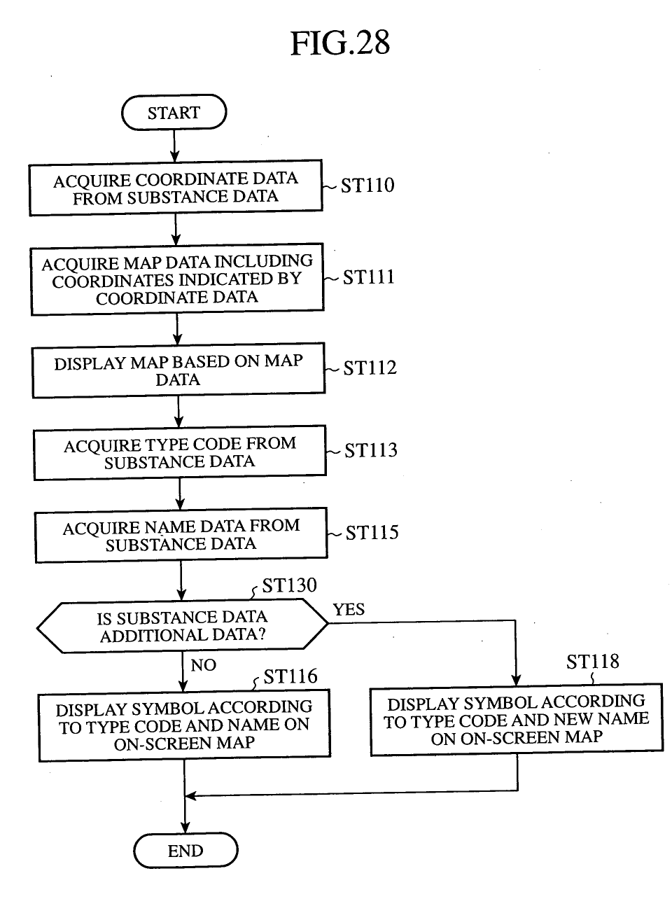

In the main processing, a process of displaying information about a retrieval target on an on-screen map is then performed. The details of the process of displaying information about a retrieval target on an on-screen map will be explained with reference to a flow chart shown in FIG. 28. Since the substance data display processing of the guidance information retrieval apparatus of this embodiment partially differs from that of embodiment 7, the same steps as those shown in the flow chart of FIG. 25 or like steps are designated by the same reference symbols and the explanation of the substance data display processing will be made briefly.

The process of displaying information about a retrieval target on an on-screen map is started when the user selects a retrieval target from two or more retrieval targets which the control unit 13 has displayed on the providing unit 15 through the substance data display processing (in step ST12 of FIG. 7) by using an operation unit 14. In the process of displaying information about a retrieval target on an on-screen map, the control unit 13 acquires coordinate data from corresponding substance data first (in step ST110). The control unit 13 then acquires map data including the coordinates of the retrieval target specified by the coordinate data (i.e., latitude and longitude data) acquired in step ST110 (in step ST111).

The control unit 13 then displays a map corresponding to the map data on the providing unit 15 (in step ST112). The control unit 13 then acquires a type code from the substance data (in step ST113). The control unit 13 then acquires name data from the substance data (in step ST115). The control unit 13 then checks to see whether or not the substance data is additional data (in step ST130). To be more specific, the control unit 13 checks to see whether it has performed acquisition (in step ST93) of additional substance data through the substance data display processing shown in FIG. 27.

When, in this step ST130, determining that the substance data is not additional data, the control unit 13 then displays both a graphic symbol according to the type code acquired in step ST113 and a name according to the name data acquired in step ST115 on the map, in step ST112, displayed on the providing unit 15 (in step ST116). As a result, the control unit 13 displays the graphic symbol showing the retrieval target and the name of the retrieval target (e.g., ◯◯ convenience store) on the on-screen map, as shown in FIG. 15.

On the other hand, when, in above-mentioned step ST130, determining that the substance data is additional data, the control unit 13 then displays both a graphic symbol according to the type code acquired in step ST113, and a name according to the name data acquired in step ST115 and an additional symbol indicating that the name is based on the additional substance data on the map, in step ST112, displayed on the providing unit 15 (in step ST118). As a result, the control unit 13 displays both the graphic symbol showing the retrieval target and the name of the retrieval target (e.g., ◯◯ convenience store) and “New” which is the additional symbol on the on-screen map, as shown in FIG. 29B.

As previously explained, the guidance information retrieval apparatus in accordance with embodiment 8 of the present invention displays the position of a retrieval target which the user has selected, as well as a graphic symbol showing the retrieval target, the name of the retrieval target and an additional symbol, on the providing unit 15. Therefore, since the user can identify which data in the guidance retrieval data is updated immediately after the guidance information retrieval apparatus has updated the guidance retrieval data, the convenience of the guidance information retrieval apparatus is improved.

### Embodiment 9

A guidance information retrieval apparatus in accordance with embodiment 9 of the present invention is so constructed as to add additional data contained in update data which are upgraded at predetermined intervals to the tail end of guidance retrieval data stored therein so as to record the additional data therein every time when the guidance retrieval data are upgraded.

The structure of the guidance information retrieval apparatus according to this embodiment is the same as the structure of the guidance information retrieval apparatus according to embodiment 1 shown in FIG. 1. A rewritable storage medium such as a hard disk is used as a guidance retrieval data holding unit 11, and a removable storage media, such as a CD or a DVD, is used as an update data holding unit 12.

FIG. 30 is a diagram showing a concept behind a data updating process performed by the guidance information retrieval apparatus in accordance with embodiment 9 of the present invention. In the guidance information retrieval apparatus, additional data A1 and A2 and A3 which are contained in update data currently being held by the update data holding unit 12 are additionally recorded into the tail end of guidance retrieval data D currently being held by the guidance retrieval data holding unit 11 one by one.

To be more specific, when the guidance retrieval data are upgraded for the first time, update data including the additional data A1 which are being held by the update data holding unit 12 are provided by the maker of the guidance information retrieval apparatus. Therefore, the guidance information retrieval apparatus additionally records, the additional data A1 contained in the update data currently being held by the update data holding unit 12 to the tail end of the guidance retrieval data D currently being held by the guidance retrieval data holding unit 11. After that, the guidance information retrieval apparatus carries out guidance retrieval processing.

When the guidance retrieval data are upgraded for the second time, update data including the additional data A2 which are being held by the update data holding unit 12 are provided by the maker of the guidance information retrieval apparatus. Therefore, the guidance information retrieval apparatus additionally records the additional data A2 contained in the update data currently being held by the update data holding unit 12 to the end of the additional data A1 currently being held by the guidance retrieval data holding unit 11. After that, the guidance information retrieval apparatus carries out guidance retrieval processing.

When the guidance retrieval data are upgraded for the third time, update data including the additional data A3 which are being held by the update data holding unit 12 are provided by the maker of the guidance information retrieval apparatus. Therefore, the guidance information retrieval apparatus additionally records the additional data A3 contained in the update data currently being held by the update data holding unit 12 to the end of the additional data A2 currently being held by the guidance retrieval data holding unit 11. After that, the guidance information retrieval apparatus carries out guidance retrieval processing. Then, every time when the guidance retrieval data are upgraded, the above-mentioned processing is repeatedly carried out.

Since the data update processing performed by the guidance information retrieval apparatus according to this embodiment is the same as that performed by the guidance information retrieval apparatus according to above-mentioned embodiment 4, the explanation of the data update processing performed by the guidance information retrieval apparatus according to this embodiment 9 will be omitted hereafter.

As explained above, the guidance information retrieval apparatus in accordance with embodiment 9 of the present invention has the following advantages. In other words, since the guidance retrieval data are generally upgraded every year, the guidance information retrieval apparatus needs to upgrade the guidance retrieval data stored therein using two or more years' additional data when it has been used for two or more years without being upgraded. Generally, since additional data which are to be added to the guidance retrieval data every year have almost equal size, the size of one year's update data required for upgrading the guidance retrieval data every year becomes almost equal. Therefore, the size of two years' update data required for upgrading the guidance retrieval data from the first version after two years have elapsed since the guidance information retrieval apparatus was made available is two times as large as that of one year's update data required for upgrading the guidance retrieval data from the first version after one year has elapsed since the guidance information retrieval apparatus was made available. Generally, the size of n years' update data required for upgrading the guidance retrieval data from the first version after n years have elapsed since the guidance information retrieval apparatus was made available is n times as large as that of one year's update data required for upgrading the guidance retrieval data from the first version after one year has elapsed since the guidance information retrieval apparatus was made available. As a result, the quantity of the update data being held by the update data holding unit 12 increases over the years.

In contrast, in the guidance information retrieval apparatus according to this embodiment 9, the additional data contained in the update data provided by the update data holding unit 12 are additionally recorded to the tail end of guidance retrieval data D when the guidance retrieval data are upgraded for the first time, and the additional data contained in the update data provided by the update data holding unit 12 are additionally recorded to the end of the additional data previously and additionally recorded to the guidance information retrieval apparatus when the guidance retrieval data are upgraded for the second or more time. Therefore, the additional data provided by the update data holding unit 12 can be simply the one to be added to the latest version of the guidance retrieval data. The present embodiment can thus offer an advantage of being able to prevent any increase in the amount of additional data provided by the update data holding unit 12.

### Embodiment 10

A guidance information retrieval apparatus in accordance with embodiment 10 of the present invention is so constructed as to perform a process of acquiring category data (refer to FIG. 9), as mentioned in embodiment 1, using a cache technology.

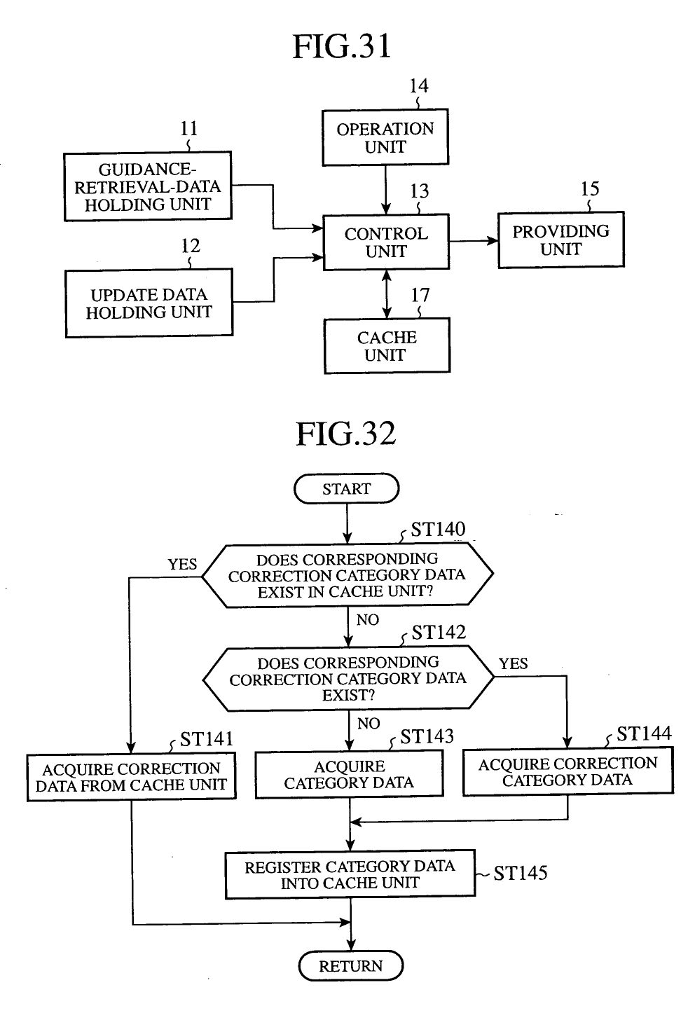

FIG. 31 is a block diagram showing the structure of the guidance information retrieval apparatus in accordance with embodiment 10 of the present invention. The guidance information retrieval apparatus has a cache unit 17 in addition to the structure of the guidance information retrieval apparatus in accordance with above-mentioned embodiment 1.

The cache unit 17 temporarily stores correction data which a control unit 13 uses during guidance retrieval processing. The contents stored in the cache unit 17 can be read by the control unit 13.

Next, the operation of the guidance information retrieval apparatus in accordance with embodiment 10 of the present invention will be explained. The guidance information retrieval apparatus according to this embodiment differs from that according to above-mentioned embodiment only in that it carries out the process of acquiring category data in a way different the way the guidance information retrieval apparatus in accordance with embodiment 1 performs the category data acquisition processing, and therefore only the category data acquisition processing will be explained with reference to a flow chart shown in FIG. 32.

In the category data acquisition processing, the control unit 13 checks to see whether correction category data corresponding to the i-th category data at an in-process level of the hierarchy exists in the cache unit 17 first (in step ST140). When, in this step, determining that correction category data exists in the cache unit 17, the control unit 13 acquires the correction category data from the cache unit 17 (in step ST141). After that, the control unit 13 returns the sequence to the original processing.

When, in above-mentioned step ST140, determining that no correction category data exists in the cache unit 17, the control unit 13 further checks to see whether correction category data corresponding to the i-th category data at the in-process level of the hierarchy exists in correction data of update data retrieved from an update data holding unit 12 (in step ST142). When, in this step, determining that no correction category data exists in the correction data of the update data, the control unit 13 acquires the i-th category data at the in-process level of the hierarchy (in step ST143).

On the other hand, when, in step ST142, determining that correction category data exists in the correction data of the update data, the control unit 13 acquires correction category data corresponding to the category data from the correction data of the update data (in step ST144). The control unit 13 then registers either the category data acquired in step ST143 or the correction category data acquired in step ST144 into the cache unit 17 (in step ST145). After that, the control unit 13 returns the sequence to the original processing.

As previously explained, the guidance information retrieval apparatus in accordance with embodiment 10 of the present invention registers either category data or correction category data which the guidance information retrieval apparatus has used once into the cache unit 17, and reads the category data or the correction category data from the cache unit 17 as needed. Therefore, as compared with a case of acquiring category data from the guidance retrieval data holding unit 11 or the update data holding unit 12, the guidance information retrieval apparatus can acquire any category data from the cache unit 17 at a higher speed.

### Embodiment 11

A guidance information retrieval apparatus in accordance with embodiment 11 of the present invention is so constructed as to be mounted in vehicles and to perform guidance retrieval processing using update data which the guidance information retrieval apparatus acquires from a center apparatus by communicating with this center apparatus. A system comprised of the guidance information retrieval apparatus and the center apparatus is called a guidance information retrieval system.

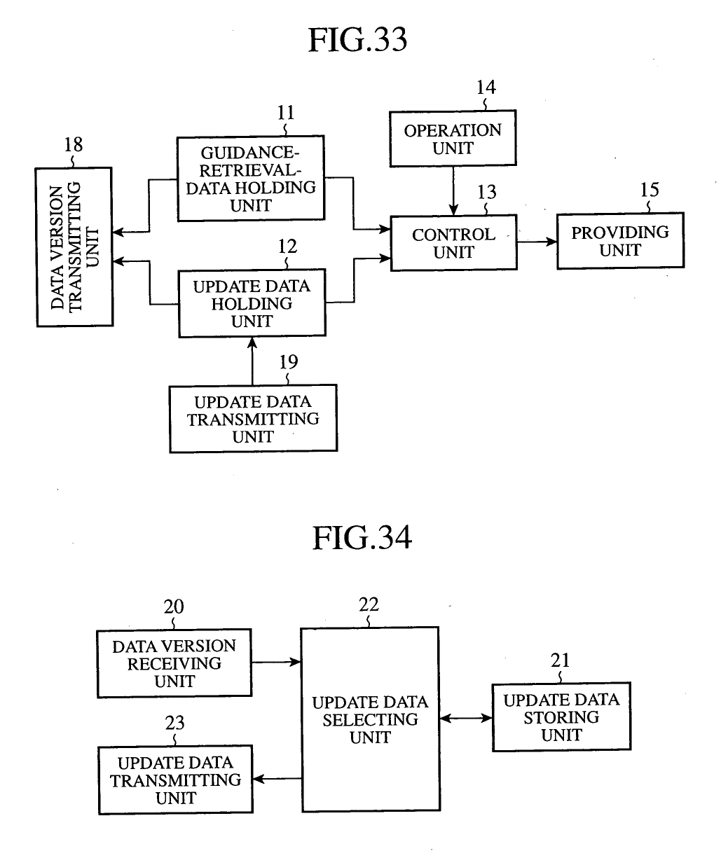

FIG. 33 is a block diagram showing the structure of the guidance information retrieval apparatus in accordance with embodiment 11 of the present invention. The guidance information retrieval apparatus according to this embodiment 11 is the one in which a data version transmitting unit 18 and an update data receiving unit 19 are added to the guidance information retrieval apparatus in accordance with above-mentioned embodiment 1. A rewritable storage medium is used as an update data holding unit 12 for use in the guidance information retrieval apparatus according to this embodiment 11.

The data version transmitting unit 18 transmits by radio the “data version” of guidance retrieval data currently being held by a guidance retrieval data holding unit 11, and a “post-update data version” of update data currently being held by the update data holding unit 12 to the center apparatus, the “post-update data version” of the update data indicating a version to which the guidance retrieval data will be upgraded using the update data. The update data receiving unit 19 receives update data sent by radio from the center apparatus. The update data received by the update data receiving unit 19 are then stored in the update data holding unit 12.

The center apparatus is provided with a data version receiving unit 20, an update data storing unit 21, an update data selecting unit 22, and an update data transmitting unit 23.

The data version receiving unit 20 receives the “data version” of the guidance retrieval data sent by radio from the guidance information retrieval apparatus, and the “post-update data version ” of the update data. The data version of the guidance retrieval data and the post-update data version of the update data received by the data version receiving unit 20 are sent to the update data selecting unit 22. The update data storing unit 21 stores two or more update data respectively corresponding to two or more versions of guidance retrieval data. Each update data stored in the update data storing unit 21 can be read by the update data selecting unit 22.

The update data selecting unit 22 reads update data of a version corresponding to the post-update data version received by the data version receiving unit 20 from the update data storing unit 21, and sends the read update data to the update data transmitting unit 23. The update data transmitting unit 23 transmits by radio the update data received from the update data selecting unit 22 to the guidance information retrieval apparatus.

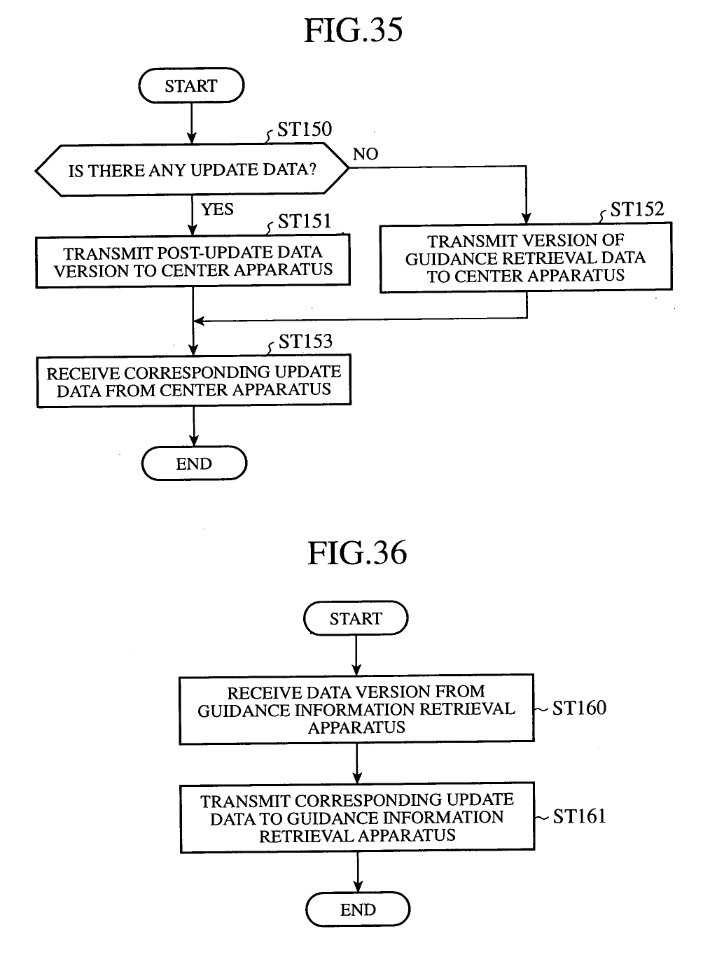

Next, the operation of the guidance information retrieval system constructed as mentioned above will be explained. First, the operation of the guidance information retrieval apparatus will be explained with reference to a flow chart shown in FIG. 35.

In the guidance information retrieval apparatus, the control unit 13 checks to see whether update data exists in the guidance information retrieval apparatus first (in step ST150). In other words, the control unit 13 checks to see whether or not update data are being held by the update data holding unit 12. When, in this step ST150, determining that update data are being held by the update data holding unit 12, the guidance information retrieval apparatus transmits a post-update data version to the center apparatus (in step ST151). In other words, the control unit 13 acquires the post-update data version from the update data currently being held by the update data holding unit 12 and sends the post-update data version to the data version transmitting unit 18, and the data version transmitting unit 18 then transmits the received post-update data version to the center apparatus by radio. After that, the control unit 13 advances the sequence to step ST153.

When, in above-mentioned step ST150, determining that no update data are being held by the update data holding unit 12, the control unit 13 transmits the data version of the guidance retrieval data stored in the guidance information retrieval apparatus to the center apparatus (in step ST152). In other words, the control unit 13 acquires the data version of the guidance retrieval data from the guidance retrieval data currently being held by the guidance retrieval data holding unit 11, and sends the data version of the guidance retrieval data to the data version transmitting unit 18, and the data version transmitting unit 18 transmits the received data version of the guidance retrieval data to the center apparatus by radio. After that, the control unit 13 advances the sequence to step ST153.

In step ST153, the guidance information retrieval apparatus receives update data which the center apparatus sends out in response to either the post-update data version which the guidance information retrieval apparatus has transmitted to the center apparatus in step ST151, or the data version of the guidance retrieval data which the guidance information retrieval apparatus has transmitted to the center apparatus in step ST152 (in step ST153). In other words, the update data receiving unit 19 receives the update data sent from the center apparatus, and stores the update data in the update data holding unit 12. The version upgrade of the update data is thus completed, and, after that, guidance retrieval processing as explained in embodiment 1 will be carried out.

Next, the operation of the center apparatus will be explained with reference to a flow chart shown in FIG. 36. The center apparatus receives the current data version of the guidance retrieval data or the like from the guidance information retrieval apparatus first (in step ST160). In other words, the data version receiving unit 20 receives the current data version or post-update data version of the guidance retrieval data sent from the guidance information retrieval apparatus, and sends it to the update data selecting unit 22.

The center apparatus then transmits corresponding update data to the guidance information retrieval apparatus (in step ST161). In other words, the update data selecting unit 22 reads either update data of a version later than the data version of the guidance retrieval data which the center apparatus has received, or update data of a version corresponding to the post-update data version of the update data which the center apparatus has received from the update data storing unit 21, and sends the read update data to the update data transmitting unit 23. The update data transmitting unit 23 then transmits the read update data to the guidance information retrieval apparatus. Thus, the update data which should be applied to the guidance retrieval data currently being held by the guidance retrieval data holding unit 11 of the guidance information retrieval apparatus are transmitted to the guidance information retrieval apparatus.

As previously explained, the guidance information retrieval apparatus in accordance with embodiment 11 of the present invention is so constructed as to upgrade the update data currently being held by the update data holding unit 12 by receiving the latest version of update data from the center apparatus. The guidance information retrieval apparatus can easily and quickly upgrade the update data stored therein.

### Embodiment 12

A guidance information retrieval apparatus in accordance with embodiment 12 of the present invention is so constructed as to be mounted in vehicles and to perform guidance retrieval processing using update data which the guidance information retrieval apparatus acquires from a center apparatus via broadcast. A system comprised of the guidance information retrieval apparatus and the center apparatus is called a guidance information retrieval system.

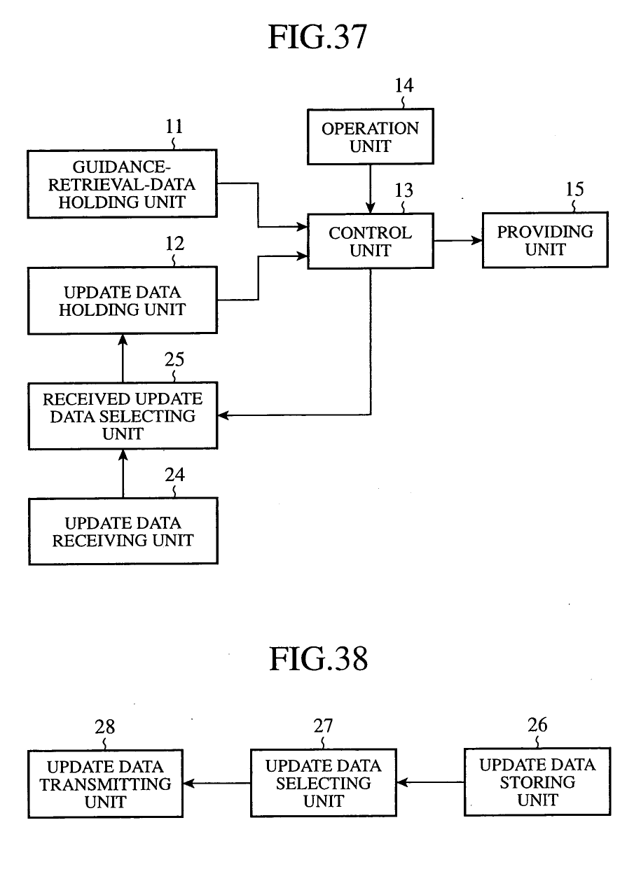

FIG. 37 is a block diagram showing the structure of the guidance information retrieval apparatus in accordance with embodiment 12 of the present invention. The guidance information retrieval apparatus according to this embodiment 12 is the one in which an update data receiving unit 24 and a received update data selecting unit 25 are added to the guidance information retrieval apparatus in accordance with above-mentioned embodiment 1. A rewritable storage medium is used as an update data holding unit 12 for use in the guidance information retrieval apparatus according to this embodiment 12.

The update data receiving unit 24 receives update data by radio and via broadcast from the center apparatus. The update data received by the update data receiving unit 24 are then sent to the received update data selecting unit 25. The received update data selecting unit 25 selects update data suitable for the current data version of the guidance retrieval data currently being held by a guidance retrieval data holding unit 11 from among update data received by the update data receiving unit 24, and sends the selected update data to the update data holding unit 12.

The center apparatus is provided with an update data storing unit 26, an update data selecting unit 27, and an update data transmitting unit 28.

The update data storing unit 26 stores two or more update data respectively corresponding to two or more versions of guidance retrieval data. Each update data stored in the update data storing unit 26 can be read by the update data selecting unit 27. The update data selection unit 27 reads the two or more versions of update data stored in the update data storing unit 26 one by one, and sequentially sends them to the update data transmitting unit 28. The update data transmitting unit 28 then transmits the update data received from the update data selecting unit 27 to the guidance information retrieval apparatus by radio and via broadcast.

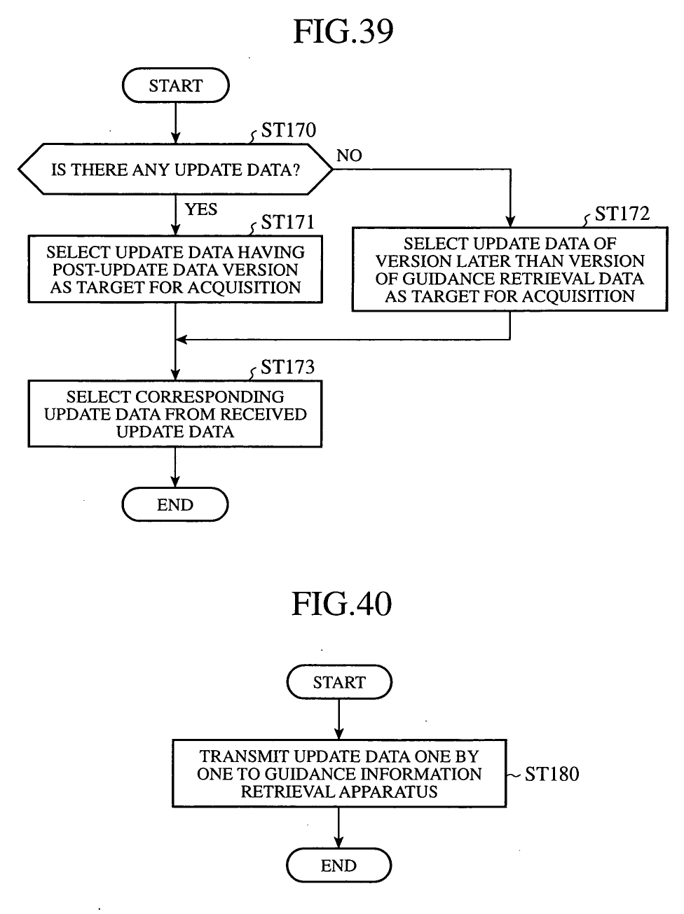

Next, the operation of the guidance information retrieval system constructed as mentioned above will be explained. First, the operation of the guidance information retrieval apparatus will be explained with reference to a flow chart shown in FIG. 39.

In the guidance information retrieval apparatus, a control unit 13 checks to see whether update data exists in the guidance information retrieval apparatus first (in step ST170). In other words, the control unit 13 checks to see whether or not update data are being held by the update data holding unit 12. When, in this step ST170, determining that update data are being held by the update data holding unit 12, the control unit 13 selects update data of a post-update data version from the update data being held by the update data holding unit 12 as a target for acquisition (in step ST171). In other words, the control unit 13 instructs the received update data selecting unit 25 to select the update data having the post-update data version. After that, the control unit 13 advances the sequence to step ST173.

When, in above-mentioned step ST170, determining that no update data are being held by the update data holding unit 12, the control unit 13 selects update data of a version later than the data version of the guidance retrieval data read from the guidance retrieval data holding unit 11 as a target for acquisition (in step ST172). In other words, the control unit 13 instructs the received update data selecting unit 25 to select update data of a version later than the data version of the guidance retrieval data. After that, the control unit 13 advances the sequence to step ST173.

In step ST173, the received update data selecting unit 25 selects corresponding update data from the received update data. Concretely, the received update data selecting unit 25 selects the update data which it is instructed to select by the control unit 13 from the two or more versions of update data sent from the update data receiving unit 24, and stores the selected update data in the update data holding unit 12. The version upgrade of the update data is thus completed, and guidance retrieval processing as explained in embodiment 1 will be carried out.

Next, the operation of the center apparatus will be explained with reference to a flow chart shown in FIG. 40. The center apparatus transmits two or more versions of update data stored therein to the guidance information retrieval apparatus one by one (in step ST180). In other words, the update data selecting unit 27 reads the two or more versions of update data one by one from the update data storing unit 26, and sends them to the update data transmitting unit 28. The update data transmitting unit 28 transmits the two or more versions of update data sent one by one from the update data selecting unit 27 to the guidance information retrieval apparatus via broadcast.

As previously explained, the guidance information retrieval apparatus in accordance with embodiment 12 of the present invention is so constructed as to upgrade update data currently being held by the update data holding unit 12 by selecting and storing update data suitable for the guidance information retrieval apparatus from two or more versions of update data transmitted thereto via broadcast from the center apparatus. Therefore, the guidance information retrieval apparatus can easily and quickly upgrade the update data stored therein. In addition, since the guidance information retrieval apparatus is so constructed as to receive update data sent thereto via broadcast, the guidance information retrieval apparatus need not have a function of transmitting the data version and post-update data version of the guidance retrieval data stored therein to the center apparatus, and therefore the structure of the guidance information retrieval apparatus can be simplified.

Many widely different embodiments of the present invention may be constructed without departing from the spirit and scope of the present invention. It should be understood that the present invention is not limited to the specific embodiments described in the specification, except as defined in the appended claims.

1. A guidance information retrieval apparatus comprising:
a guidance retrieval data holding means for holding guidance retrieval data including both category data each specifying a category in which retrieval targets are put, and substance data each specifying substance of a corresponding retrieval target;
an update data holding means for holding update data including both correction data each used for correcting either category data or substance data which constitutes said guidance retrieval data, and additional data each used for adding new category data or substance data to said guidance retrieval data;
a control means for, when correction data corresponding to either category data or substance data contained in said guidance retrieval data acquired from said guidance retrieval data holding means is contained in the update data acquired from said update data holding means, outputting either a category in which a retrieval target corresponding to the correction data is put or substance of the retrieval target, and for, when additional data is contained in the update data acquired from said update data holding means, outputting either a category in which a retrieval target corresponding to the additional data is put or substance of the retrieval target; and
a providing means for providing the category in which the retrieval target is put or the substance of the retrieval target according to the output of said control means.

2. The guidance information retrieval apparatus according to claim 1, wherein said apparatus further comprises a map data storage means for storing map data, and said control means reads map data specified by coordinates included in substance data from said map data storage means, and outputs a map which is generated based on the map data and on which a graphical symbol and a name showing substance of a retrieval target specified by said substance data are superimposed to said providing means.

3. The guidance information retrieval apparatus according to claim 1, wherein said guidance retrieval data holding means includes a rewritable storage medium, and said control means adds the additional data contained in the update data acquired from said update data holding means to an end of the guidance retrieval data stored in said rewritable storage medium so as to store the additional data in said rewritable storage medium.

4. The guidance information retrieval apparatus according to claim 2, wherein said guidance retrieval data holding means includes a rewritable storage medium, and said control means adds the additional data contained in the update data acquired from said update data holding means to an end of the guidance retrieval data stored in said rewritable storage medium so as to store the additional data in said rewritable storage medium.

5. The guidance information retrieval apparatus according to claim 1, wherein the guidance retrieval data held by said guidance retrieval data holding means have a hierarchical structure in which two or more hierarchy levels including, as a top hierarchy level, categories of types are formed, and the update data held by said update data holding means contain either correction data or additional data at a lower hierarchy level, which are-associated with the categories of types at said top hierarchy level.

6. The guidance information retrieval apparatus according to claim 2, wherein the guidance retrieval data held by said guidance retrieval data holding means have a hierarchical structure in which two or more hierarchy levels including, as a top hierarchy level, categories of types are formed, and the update data held by said update data holding means contain either correction data or additional data at a lower hierarchy level, which are associated with the categories of types at said top hierarchy level.

7. The guidance information retrieval apparatus according to claim 1, wherein the guidance retrieval data held by said guidance retrieval data holding means have a hierarchic structure in which two or more hierarchy levels including, as a top hierarchy level, categories of areas are formed, and the update data held by said update data holding means contain either correction data or additional data at a lower hierarchy level, which are associated with the category of areas at said top hierarchy level.

8. The guidance information retrieval apparatus according to claim 2, wherein the guidance retrieval data held by said guidance retrieval data holding means have a hierarchic structure in which two or more hierarchy levels including, as a top hierarchy level, categories of areas are formed, and the update data held by said update data holding means contain either correction data or additional data at a lower hierarchy level, which are associated with the category of areas at said top hierarchy level.

9. The guidance information retrieval apparatus according to claim 2, wherein when correction data corresponding to substance data contained in the guidance retrieval data acquired from said guidance retrieval data holding means is contained in the update data acquired from said update data holding means, said control means superimposes both substance of a retrieval target corresponding to the substance data contained in said guidance retrieval data and substance of a retrieval target corresponding to said correction data on the map generated based on the map data read from said map data storage means, and then outputs them superimposed on the map to said providing means.

10. The guidance information retrieval apparatus according to claim 2, wherein when additional data is contained in the update data acquired from said update data holding means, said control means adds an additional symbol indicating that substance of a retrieval target corresponding to the additional data is based on the additional data to the substance of the retrieval target, superimposes the additional symbol on the map generated based on the map data read from said map data storage means, and then outputs it superimposed on the map to said providing means.

11. The guidance information retrieval apparatus according to claim 1, wherein said guidance retrieval data holding means is a rewritable storage medium, the update data held by said update data holding means include additional data of a version, and said control means adds additional data of a predetermined version contained in the update data acquired from said update data holding means to either an end of the guidance retrieval data stored in said rewritable storage medium or an end of additional data of a previous version already and additionally stored in said rewritable storage medium so as to store the additional data of the predetermined version in said rewritable storage medium.

12. The guidance information retrieval apparatus according to claim 2, wherein said guidance retrieval data holding means is a rewritable storage medium, the update data held by said update data holding means include additional data of a version, and said control means adds additional data of a predetermined version contained in the update data acquired from said update data holding means to either an end of the guidance retrieval data stored in said rewritable storage medium or an end of additional data of a previous version already and additionally stored in said rewritable storage medium so as to store the additional data of the predetermined version in said rewritable storage medium.

13. The guidance information retrieval apparatus according to claim 1, wherein said apparatus further includes a cache means for temporarily storing update data acquired from said update data holding means, and, when acquiring update data from said update data holding means, said control means acquires the update data from this cache means if the update data is stored in said cache means, whereas said control means acquires the update data from said update data holding means and then stores the acquired update data in said cache means if the update data is not stored in said cache means.

14. The guidance information retrieval apparatus according to claim 2, wherein said apparatus further includes a cache means for temporarily storing update data acquired from said update data holding means, and, when acquiring update data from said update data holding means, said control means acquires the update data from this cache means if the update data is stored in said cache means, whereas said control means acquires the update data from said update data holding means and then stores the acquired update data in said cache means if the update data is not stored in said cache means.

15. A guidance information retrieval system including a guidance information retrieval apparatus and a center apparatus connected by radio to the guidance information retrieval apparatus, said guidance information retrieval apparatus comprising:
a guidance retrieval data holding means for holding guidance retrieval data including both category data each specifying a category in which retrieval targets are put, and substance data each specifying substance of a corresponding retrieval target; an update data receiving means for receiving update data including both correction data each used for correcting either category data or substance data which constitutes said guidance retrieval data, and additional data each used for adding new category data or substance data to said guidance retrieval data from said center apparatus;
an update data holding means for holding the update data received by said update data receiving means;
a control means for, when correction data corresponding to either category data or substance data contained in said guidance retrieval data acquired from said guidance retrieval data holding means is contained in the update data acquired from said update data holding means, outputting either a category in which a retrieval target corresponding to the correction data is put or substance of the retrieval target, and for, when additional data is contained in the update data acquired from said update data holding means, outputting either a category in which a retrieval target corresponding to the additional data is put or substance of the retrieval target; and
a providing means for providing the category in which the retrieval target is put or the substance of the retrieval target according to the output of said control means,
and wherein said center apparatus comprises:
an update data storing means for storing the update data; and
an update data transmitting means for transmitting the update data stored in said update data storing means to said guidance information retrieval apparatus.
